(19) United States
(12) Patent Application Publication
(10) Pub. No.: US 2026/0361391 A1
(43) Pub. Date: Nov. 12, 2026

(54) BEAM PAIR PREDICTION BASED ON RECEIVE BEAM

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/139,205

(22) PCT Filed: Feb. 16, 2023
(86) PCT No.: PCT/CN2023/076341

§ 371 Date: Jun. 13, 2025

(51) Int. Cl. H04B 7/08; H04W 24/10; H04W 72/044; H04W 72/231

(52) U.S. Cl. CPC H04B 7/088; H04W 24/10; H04W 72/046; H04W 72/231

(57) ABSTRACT

Methods, systems, and devices for wireless communications are described. The described techniques provide for a user equipment (UE) to transmit one or more sounding reference signals (SRSs) to indicate receive beam information of the UE. In some cases, the SRSs may be mapped to various receive beams of the UE according to a correspondence between SRS resource sets available to the UE and the receive beams of the UE. The mapping may be configured according to a predefined rule, a radio resource control (RRC) configuration, dynamic indications from the UE, or a combination thereof. In some cases, the UE may indicate a receive beam via a measurement report or may receive an indication of one or more receive beams from a network entity.

### CROSS REFERENCE

The present Application for Patent is a 371 national phase filing of International Patent Application No. PCT/CN2023/076341 by LI et al., entitled “BEAM PAIR PREDICTION BASED ON RECEIVE BEAM,” filed Feb. 16, 2023, assigned to the assignee hereof, and expressly incorporated by reference herein.

### FIELD OF TECHNOLOGY

The following relates to wireless communications, including beam pair prediction based on receive beam.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support beam pair prediction based on receive beam. For example, the described techniques enable a user equipment (UE) to transmit one or more sounding reference signals (SRSs) or SRS resources to indicate receive beam information of the UE. In some cases, the SRSs or SRS resources may be mapped to various receive beams of the UE according to a correspondence or association between SRS resource sets available for the UE and the receive beams of the UE. The mapping may be configured according to a predefined rule (e.g., defined in a technical standard), a radio resource control (RRC) configuration (e.g., RRC preconfigured), dynamic indications from the UE, or a combination thereof. Additionally, or alternatively, the UE may indicate a receive beam via a measurement report (e.g., indicating SRS resources associated with one or more the receive beams used to measure a channel measurement resource (CMR)) or the UE may receive an indication of one or more receive beams from a network entity (e.g., implicitly indicated to the UE by the network entity indicating SRS resources).

A method for wireless communication at a UE is described. The method may include transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and receiving one or more messages using a receive beam of the one or more receive beams based on the receive beam information.

An apparatus for wireless communication at a UE is described. The apparatus may include a memory, and a processor coupled to the memory. The processor may be configured to transmit one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and receive one or more messages using a receive beam of the one or more receive beams based on the receive beam information.

Another apparatus for wireless communication at a UE is described. The apparatus may include means for transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and means for receiving one or more messages using a receive beam of the one or more receive beams based on the receive beam information.

A non-transitory computer-readable medium storing code for wireless communication at a UE is described. The code may include instructions executable by a processor to transmit one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and receive one or more messages using a receive beam of the one or more receive beams based on the receive beam information.

Some examples of the method, apparatuses, and non-transitory computer-readable medium described herein may further include operations, features, means, or instructions for receiving RRC signaling indicating one or more rules for the mapping between the one or more resource sets and one or more receive beams of the UE, where transmitting the one or more reference signals may be based at least in part the RRC signaling and the one or more rules.

In some examples of the method, apparatuses, and non-transitory computer-readable medium described herein, transmitting the one or more reference signals via the one or more resource sets may include operations, features, means, or instructions for transmitting the one or more reference signals via the one or more resource sets based on a rule for the mapping between the one or more resource sets and one or more receive beams of the UE.

Some examples of the method, apparatuses, and non-transitory computer-readable medium described herein may further include operations, features, means, or instructions for transmitting a message indicating one or more rules for the mapping between the one or more resource sets and one or more receive beams of the UE, where transmitting the one or more reference signals may be based on the one or more rules.

In some examples of the method, apparatuses, and non-transitory computer-readable medium described herein, the message includes an indication of one or more resources of a first subset of the set of multiple resource sets or of a second subset of the set of multiple resource sets, the first subset may be allocated for reference signal transmission, and the second subset may be allocated for beam identification usage.

In some examples of the method, apparatuses, and non-transitory computer-readable medium described herein, transmitting the message may include operations, features, means, or instructions for transmitting a medium access control control element (MAC-CE) indicating the one or more resource sets or one or more resources of the one or more resource sets, where the one or more messages may be received based on a time delay after acknowledgement of the MAC-CE.

In some examples of the method, apparatuses, and non-transitory computer-readable medium described herein, transmitting the message may include operations, features, means, or instructions for transmitting uplink control information (UCI) indicating the one or more resource sets or one or more resources of the one or more resource sets, where the one or more messages may be received based on a quantity of slots after transmitting the UCI.

In some examples of the method, apparatuses, and non-transitory computer-readable medium described herein, and the method, apparatuses, and non-transitory computer-readable medium may include further operations, features, means, or instructions for receiving the one or more messages in accordance with a set of multiple pointing directions associated with the receive beam and a set of multiple beamwidths associated with the receive beam and receiving the one or more messages in accordance with a first pointing direction associated with the receive beam and a first beamwidth associated with the receive beam, the first pointing direction and the first beamwidth based on a spatial filter associated with a transmit beam of the UE used to transmit one or more reference signals.

Some examples of the method, apparatuses, and non-transitory computer-readable medium described herein may further include operations, features, means, or instructions for receiving, based on transmitting the one or more reference signals, a message indicating at least one resource of the one or more resource sets, the at least one resource for reception of the one or more messages using the receive beam, where the one or more messages include a downlink shared channel, a downlink control channel, or a combination thereof.

In some examples of the method, apparatuses, and non-transitory computer-readable medium described herein, the message includes one or more first identifiers (IDs) associated with the at least one resource, one or more second IDs associated with the one or more resource sets, one or more third IDs associated with at least the receive beam, or any combination thereof.

In some examples of the method, apparatuses, and non-transitory computer-readable medium described herein, the message may include a RRC message indicating a transmission configuration indicator (TCI) state for the UE; a MAC-CE indicating an activation of the TCI state of the UE; a downlink control information (DCI) message indicating a command to switch from a first transmission indicator state of the UE to a second transmission indicator state of the UE; or an indication of quasi co-location (QCL) information for receiving the one or more messages.

In some examples of the method, apparatuses, and non-transitory computer-readable medium described herein, the one or more reference signals may be associated with an ordering that may be based on one or more first IDs associated with the one or more resource sets, one or more second IDs associated with one or more resources of the one or more resource sets, or any combination thereof.

Some examples of the method, apparatuses, and non-transitory computer-readable medium described herein may further include operations, features, means, or instructions for transmitting a capability report indicating one or more capabilities of the UE, the one or more capabilities including a first quantity of resources associated with each resource set of the set of multiple resource sets, a capability to support communication of the one or more reference signals via a set of multiple antenna ports associated with the UE, a second quantity of antenna ports of the set of multiple antenna ports associated with the first quantity of resources of each resource set of the one or more resource sets, a second quantity of resources associated with the one or more resource sets, a third quantity of active antenna ports of the set of multiple antenna ports, or any combination thereof, where transmitting the one or more reference signals may be based on transmitting the capability report.

In some examples of the method, apparatuses, and non-transitory computer-readable medium described herein, the mapping between the one or more resource sets and the one or more receive beams of the UE may be based on a frequency band associated with the one or more resource sets, a serving cell associated with the one or more resource sets, a bandwidth part associated with the one or more resource sets, or any combination thereof.

In some examples of the method, apparatuses, and non-transitory computer-readable medium described herein, the mapping between the one or more resource sets and one or more receive beams of the UE may be based on a usage mode associated with the one or more resource sets, the usage mode indicating that the set of multiple resource sets correspond to the set of multiple receive beams of the UE.

A method for wireless communication at a UE is described. The method may include monitoring a CMR for a reference signal using at least one receive beam of a set of multiple receive beams of the UE, generating at least one reference signal measurement for the reference signal based on monitoring the CMR, and transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

An apparatus for wireless communication at a UE is described. The apparatus may include a memory, and a processor coupled to the memory. The processor may be configured to monitor a CMR for a reference signal using at least one receive beam of a set of multiple receive beams of the UE, generate at least one reference signal measurement for the reference signal based on monitoring the CMR, and transmit a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

Another apparatus for wireless communication at a UE is described. The apparatus may include means for monitoring a CMR for a reference signal using at least one receive beam of a set of multiple receive beams of the UE, means for generating at least one reference signal measurement for the reference signal based on monitoring the CMR, and means for transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

A non-transitory computer-readable medium storing code for wireless communication at a UE is described. The code may include instructions executable by a processor to monitor a CMR for a reference signal using at least one receive beam of a set of multiple receive beams of the UE, generate at least one reference signal measurement for the reference signal based on monitoring the CMR, and transmit a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

In some examples of the method, apparatuses, and non-transitory computer-readable medium described herein, the measurement report includes a first ID associated with the at least one reference signal resource, a second ID associated with a resource set for the UE including the at least one reference signal resource, a third ID associated with the at least one receive beam, a spatial filter associated with a transmit beam of the UE used to transmit the measurement report, or any combination thereof.

Some examples of the method, apparatuses, and non-transitory computer-readable medium described herein may further include operations, features, means, or instructions for transmitting a capability report indicating a capability of the UE to report a quantity of receive beams associated with the at least one receive beam used to monitor the CMR, where the measurement report includes an indication of the quantity of receive beams.

A method for wireless communication at a network entity is described. The method may include receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and transmitting one or more messages to the UE, the one or more messages indicating at least one of the one or more resource sets based on the receive beam information.

An apparatus for wireless communication at a network entity is described. The apparatus may include a memory, and a processor coupled to the memory. The processor may be configured to receive one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and transmit one or more messages to the UE, the one or more messages indicating at least one of the one or more resource sets based on the receive beam information.

Another apparatus for wireless communication at a network entity is described. The apparatus may include means for receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and means for transmitting one or more messages to the UE, the one or more messages indicating at least one of the one or more resource sets based on the receive beam information.

A non-transitory computer-readable medium storing code for wireless communication at a network entity is described. The code may include instructions executable by a processor to receive one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE and transmit one or more messages to the UE, the one or more messages indicating at least one of the one or more resource sets based on the receive beam information.

Some examples of the method, apparatuses, and non-transitory computer-readable medium described herein may further include operations, features, means, or instructions for transmitting RRC signaling indicating one or more rules for the mapping between the one or more resource sets and one or more receive beams of the UE, where receiving the one or more reference signals may be based on the RRC signaling and the one or more rules.

In some examples of the method, apparatuses, and non-transitory computer-readable medium described herein, receiving the one or more reference signals via the one or more resource sets may include operations, features, means, or instructions for receiving the one or more reference signals via the one or more resource sets based on a rule for the mapping between the one or more resource sets and one or more receive beams of the UE.

Some examples of the method, apparatuses, and non-transitory computer-readable medium described herein may further include operations, features, means, or instructions for receiving a message indicating the one or more rules for the mapping between the one or more resource sets and one or more receive beams of the UE, where receiving the one or more reference signals may be based on the one or more rules.

In some examples of the method, apparatuses, and non-transitory computer-readable medium described herein, the message includes an indication of one or more resources of a first subset of the set of multiple resource sets or of a second subset of the set of multiple resource sets, the first subset may be allocated for reference signal transmission, and the second subset may be allocated for beam identification usage.

Some examples of the method, apparatuses, and non-transitory computer-readable medium described herein may further include operations, features, means, or instructions for transmitting, based on receiving the one or more reference signals, a message indicating at least one resource of the one or more resource sets, the at least one resource for transmission of the one or more messages, where the one or more messages include a downlink shared channel, a downlink control channel, or a combination thereof.

In some examples of the method, apparatuses, and non-transitory computer-readable medium described herein, the one or more reference signals may be associated with an ordering that may be based on one or more first IDs associated with the one or more resource sets, one or more second indices associated with one or more resources of the one or more resource sets, or any combination thereof.

Some examples of the method, apparatuses, and non-transitory computer-readable medium described herein may further include operations, features, means, or instructions for receiving a capability report indicating one or more capabilities of the UE, the one or more capabilities including a first quantity of resources associated with each resource set of the set of multiple resource sets, a capability to support communication of the one or more reference signals via a set of multiple antenna ports associated with the UE, a second quantity of antenna ports of the set of multiple antenna ports associated with the first quantity of resources of each resource set of the one or more resource sets, a second quantity of resources associated with the one or more resource sets, a third quantity of active antenna ports of the set of multiple antenna ports, or any combination thereof, where receiving the one or more reference signals may be based on transmitting the capability report.

In some examples of the method, apparatuses, and non-transitory computer-readable medium described herein, the mapping between the one or more resource sets and the one or more receive beams of the UE may be based on a frequency band associated with the one or more resource sets, a serving cell associated with the one or more resource sets, a bandwidth part associated with the one or more resource sets, or a combination thereof.

A method for wireless communications at a network entity is described. The method may include transmitting one or more reference signals via one or more CMRs and receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

An apparatus for wireless communications at a network entity is described. The apparatus may include a memory, and a processor coupled to the memory. The processor may be configured to transmit one or more reference signals via one or more CMRs and receive a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

Another apparatus for wireless communications at a network entity is described. The apparatus may include means for transmitting one or more reference signals via one or more CMRs and means for receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

A non-transitory computer-readable medium storing code for wireless communications at a network entity is described. The code may include instructions executable by a processor to transmit one or more reference signals via one or more CMRs and receive a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

In some examples of the method, apparatuses, and non-transitory computer-readable medium described herein, the measurement report includes a first ID associated with the at least one reference signal resource, a second ID associated with a resource set for the UE including the at least one reference signal resource, a third ID associated with the at least one receive beam, a spatial filter associated with a transmit beam of the UE used to transmit the measurement report, or any combination thereof.

Some examples of the method, apparatuses, and non-transitory computer-readable medium described herein may further include operations, features, means, or instructions for receiving a capability report indicating a capability of the UE to report a quantity of receive beams associated with the at least one receive beam used to monitor the CMR, where the measurement report includes an indication of the quantity of receive beams.

### BRIEF DESCRIPTION OF THE DRAWINGS

FIG. 1 illustrates an example of a wireless communications system that supports beam pair prediction based on receive beam in accordance with one or more aspects of the present disclosure.

FIG. 2 illustrates an example of a wireless communications system that supports beam pair prediction based on receive beam in accordance with one or more aspects of the present disclosure.

FIG. 3 illustrates an example of a mapping diagram that supports beam pair prediction based on receive beam in accordance with one or more aspects of the present disclosure.

FIG. 4 illustrates an example of a process flow that supports beam pair prediction based on receive beam in accordance with one or more aspects of the present disclosure.

FIGS. 5 and 6 illustrate block diagrams of devices that support beam pair prediction based on receive beam in accordance with one or more aspects of the present disclosure.

FIG. 7 illustrates a block diagram of a communications manager that supports beam pair prediction based on receive beam in accordance with one or more aspects of the present disclosure.

FIG. 8 illustrates a diagram of a system including a device that supports beam pair prediction based on receive beam in accordance with one or more aspects of the present disclosure.

FIGS. 9 and 10 illustrate block diagrams of devices that support beam pair prediction based on receive beam in accordance with one or more aspects of the present disclosure.

FIG. 11 illustrates a block diagram of a communications manager that supports beam pair prediction based on receive beam in accordance with one or more aspects of the present disclosure.

FIG. 12 illustrates a diagram of a system including a device that supports beam pair prediction based on receive beam in accordance with one or more aspects of the present disclosure.

FIGS. 13 through 16 illustrate flowcharts showing methods that support beam pair prediction based on receive beam in accordance with one or more aspects of the present disclosure.

### DETAILED DESCRIPTION

In some cases, a user equipment (UE) may perform communications using one or more receive beams available to or supported by the UE for wireless communications. Each receive beam may correspond to a respective transmission configuration indicator (TCI) state. A network entity communicating with the UE may predict beam pairs (e.g., a pairing of a transmit beam of the network entity and a receive beam of the UE), and may utilize information about a receive beam of the UE in order to support such a prediction of beam pair(s) or pairing(s). For example, the network entity may identify or determine a beam direction, a beamwidth, or both for the receive beam as part of beam pair prediction. However, directly indicating such receive beam information, by the UE for example, may result in the disclosure of secure or proprietary information of the UE (e.g., proprietary information regarding an internal architecture, components, algorithm(s), or logic used by the UE) and may in some cases, result in increased signaling overhead (e.g., due to reporting receive beam information dynamically or based on frequent updates (e.g., due to rotation or movement of the UE)). Accordingly, techniques for communicating information about receive beams for the UE without the UE having to explicitly indicate proprietary information such as beamwidths, gains, etc. may be beneficial and may reduce signaling overhead.

To support indicating receive beam information, a UE may transmit one or more sounding reference signals (SRSs) that correspond to receive beams of the UE. For instance, the SRSs may be mapped to various receive beams of the UE according to a correspondence between SRS resource sets used by the UE for the SRS transmissions and the receive beams of the UE. The mapping may be based on a predefined rule (e.g., defined in a technical standard). In some cases, the mapping may be indicated to the UE via a radio resource control (RRC) message (e.g., RRC preconfigured), or the mapping may be indicated by the UE in a dynamic indication. Additionally, or alternatively, the UE may indicate a receive beam via a measurement report by indicating SRS resources associated with one or more the receive beams used to measure one or more channel measurement resource (CMRs) or the UE may receive an indication of one or more receive beams from the network entity (e.g., indicated by the network entity based on SRS resources). By associating receive beams of the UE with SRSs transmitted by the UE or SRS resources used or available for the UE, the network entity may use this receive beam information to predict beam pairs without an explicit indication of proprietary information of the UE such as beam weights, beamwidths, gain, etc.

Aspects of the disclosure are initially described in the context of wireless communications systems. Aspects of the disclosure are further illustrated by and described with reference to a mapping diagram and a process flow. Aspects of the disclosure are further illustrated by and described with reference to apparatus diagrams, system diagrams, and flowcharts that relate to beam pair prediction based on receive beam.

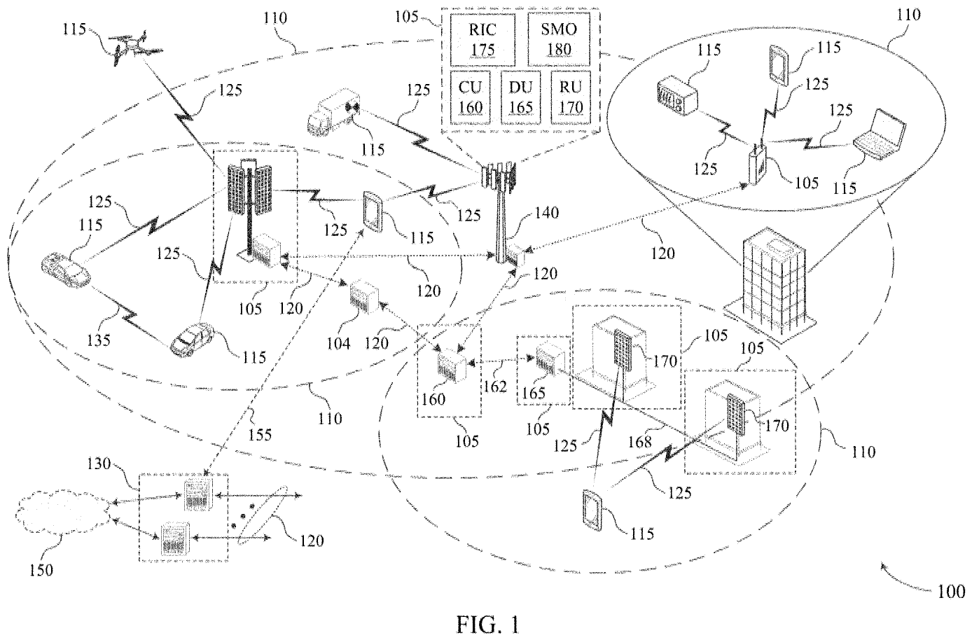

FIG. 1 illustrates an example of a wireless communications system 100 that supports beam pair prediction based on receive beam in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support beam pair prediction based on receive beam as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In wireless communications systems, such as the wireless communication system 100, a UE 115 may perform communications using one or more receive beams available to the UE 115. A network entity 105 communicating with the UE 115 may predict beam pairs (e.g., a pairing of a transmit beam of the network entity 105 and a receive beam of the UE 115), and may utilize information about a receive beam of the UE 115 in order to support beam pair prediction. For example, the network entity 105 may identify a beam direction, a beamwidth, or both for the receive beam as part of beam pair prediction. However, directly indicating such receive beam information may result in the disclosure of secure information associated with the UE 115 (e.g., proprietary information regarding an internal architecture of the UE 115) and may incur greater signaling overhead due to reporting receive beams as the receive beam information dynamically updates (e.g., due to rotation or movement of the UE 115).

To support implicitly indicating receive beam information to a network entity 105, a UE 115 may transmit one or more SRSs that correspond to receive beams of the UE 115. For instance, the SRSs may be mapped to various receive beams of the UE 115 according to a correspondence between SRS resource sets available to the UE 115 and the receive beams of the UE 115. The mapping may be configured according to a predefined rule (e.g., defined in a technical standard), a RRC configuration (e.g., RRC preconfigured), dynamic indications from the UE 115, or a combination thereof. Additionally, or alternatively, the UE 115 may indicate a receive beam via a measurement report (e.g., indicating SRS resources associated with one or more the receive beams used to measure a CMR) or may receive an indication of one or more receive beams from the network entity 105 (e.g., indicated by SRS resources). By associating receive beams of the UE 115 with SRSs transmitted by the UE 115, the network entity 105 may identify receive beam information to predict beam pairs.

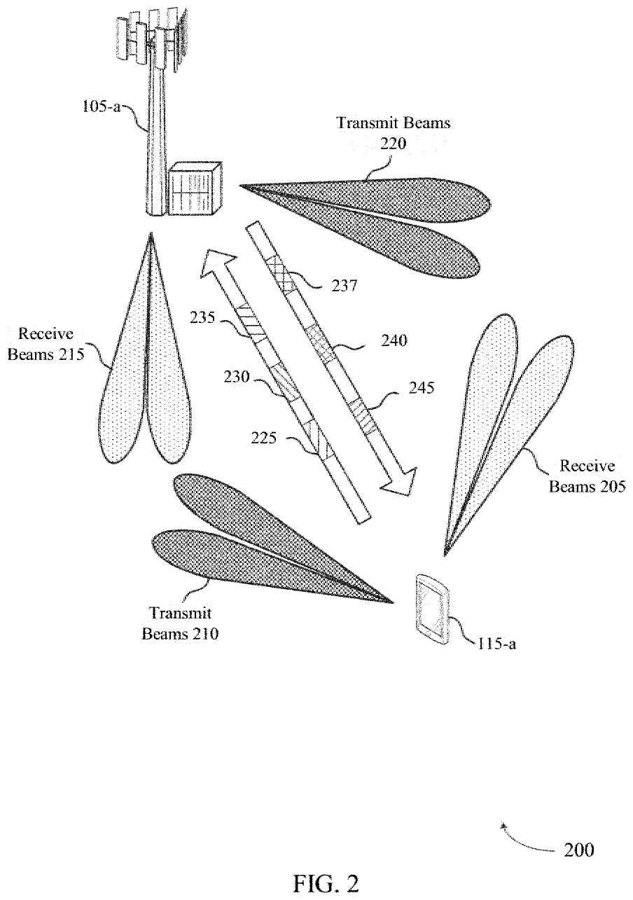

FIG. 2 illustrates an example of a wireless communications system 200 that supports beam pair prediction based on receive beam in accordance with one or more aspects of the present disclosure. The wireless communications system 200 may include one or more aspects of the wireless communications system 100. For example, the wireless communications system 200 may include a network entity 105-a and a UE 115-a, which may be example of corresponding devices described with reference to FIG. 1. In some cases, the network entity 105-a and the UE 115-a may communicate beamformed communications using transmit beams, receive beams, or both. For example, the UE 115-a may be associated with a set of receive beams 205 and a set of transmit beams 210, and the network entity 105-a may be associated with a set of receive beams 215 and a set of transmit beams 220.

In some cases, the network entity 105-a may predict a beam pair quality for a transmit beam 220 of the network entity 105-a and a receive beam 205 of the UE 115-a. For example, the network entity 105-a may identify a signal strength for a transmit beam 220 and a receive beam 205 as part of a beam pair prediction. Such predictions may support a reduced power consumption for the UE 115-a (e.g., when executing artificial intelligence (AI) or machine learning (ML) algorithms). To facilitate beam pair prediction, the network entity 105-a may utilize information regarding the first receive beam 205, such a pointing direction, a beamwidth, a beamforming gain, or a combination thereof. However, explicit indication of such receive beam information (e.g., in a message from the UE 115-a) may result in the disclosure of secure information associated with the UE 115-a (e.g., proprietary information regarding an internal architecture, components, algorithm(s), or logic used by the UE 115-a) and may result in increased signaling overhead due to reporting receive beams as the receive beam information dynamically updates (e.g., due to rotation or movement of the UE 115-a). Proprietary information may include receive beam pointing directions, beamwidths, beamforming gains or antenna element gains, among other information associated with the UE 115-a.

To support indicating receive beam information to the network entity 105-a without disclosing proprietary information, the UE 115-a may transmit one or more reference signals 225 (e.g., SRSs) that correspond to the receive beams 205 of the UE 115-a using the transmit beams 210. For instance, the reference signals 225 may be mapped to various receive beams 205 according to a correspondence or association between SRS resource sets available to or used by the UE 115-a (e.g., for transmission of the reference signals 225) and the receive beams 205. The network entity 105-a may receive the reference signals 225 using one or more receive beams 215, and may identify receive beam information associated with one or more of the receive beams 205 based on the reference signals 225 and the mapping by using an AI or ML model. The AI or ML model may enable the network entity 105-a to identify the receive beam information via channel characteristics estimated from SRS resources indicated by the UE.

As an example, the AI or ML model may take one or more inputs to support identifying receive beam information. For example, the inputs may include a sparse vector representing UE receive beam information, where different elements of the sparse vector may be associated with different pointing directions of UE receive beams (e.g., where non-zero elements indicate that there exists a UE receive beam pointing at such a direction). Additionally, or alternatively, the inputs may include one or more (e.g., a subset or all of) L1 reference signal received power (L1-RSRP) measurements for each of the transmit beams 220 of the network entity 105-a (e.g., N_{Tx} beams). For example, the UE 115-a may measure a reference signal for each transmit beam 220 with one or more receive beams 205 (e.g., N_{Rx} candidate UE beams) of the UE 115-a (e.g., N_{Tx}*N_{Rx} beam pairs). In some cases, the inputs may include candidate receive beams 205 of the UE 115-a (e.g., beams used for measuring N_{Tx} beam pairs).

According to the one or more inputs, the model may output L1-RSRP measurements with respect to each beam pair (e.g., the N_{Tx}*N_{Rx} beam pairs), which the network entity 105-a may use to identify the receive beam information. For example, the network entity 105-a may take each L1-RSRP measurement associated with each beam pair (e.g., L1-RSRP₁₋₁ via CMR₁*R_{X1}, L1-RSRP₁₋₂ via CMR₁*R_{X2}, . . . , L1-RSRP₈₋₆ via CMR₈*R_{X6}, L1-RSRP₈₋₇ from CMR₈*R_{X7}), and may determine the sparse vector indicating the receive beam information based on each L1-RSRP measurement.

In a first example, the mapping between the reference signals 225 and the receive beams 205 may be based on one or more predefined rules (e.g., defined or indicated by a technical standard). Additionally, or alternatively, the mapping between the reference signals 225 and the receive beams 205 may be based on one or more preconfigured rules (e.g., communicated via RRC signaling) indicated to the UE 115-a from the network entity 105-a. Such rules (e.g., predefined or preconfigured) may indicate one or more resource sets available to the UE 115-a that have a usage mode associated with mapping resources of the one or more resource sets to the receive beams 205 (e.g., usage=RxBeamIdentification). For example, the UE 115-a may identify one or more SRS resource sets associated with the usage mode, and may transmit the reference signals 225 via SRS resources of the one or more SRS resource sets. In some examples, the UE 115-a may identify that one or more SRS resources of the one or more SRS resource sets correspond to multiple SRS ports, and may be operable to communicate with multiple receive beams 205 via such SRS resources (e.g., for receiving multi-rank physical downlink shared channel (PDSCH) transmissions).

In some examples, the UE 115-a may indicate, by transmitting the reference signals 225 using the transmit beams 210, the receive beams 205 based on indexing the receive beams 205 according to one or more identifiers (IDs) associated with the one or more SRS resource sets (e.g., each associated with the usage mode), one or more IDs associated with SRS resources of the SRS resource sets, or both. For example, if the UE 115-a actively transmits SRS resources from multiple SRS resource sets, the UE 115-a may index the receive beams 205 according to an ordering of the SRS resource set IDs associated with the one or more SRS resource sets and may, in some cases, index the receive beams 205 according to an ordering of the SRS resource IDs (e.g., after ordering according to SRS resource set ID) associated with SRS resources of the one or more SRS resource sets. As another example, such as when the UE 115-a actively transmits SRS resources from a single SRS resource set, the UE 115-a may index the receive beams 205 according to an ordering of the SRS resource IDs associated with the SRS resource set. Additionally, or alternatively, the indexing of the receive beams 205 may be based on a periodicity of the one or more SRS resource sets (e.g., each SRS resource set being periodic or semi-persistently scheduled). In some cases, the UE 115-a may apply the receive beams 205 indicated by the reference signals 225 (e.g., according to the SRS resource IDs, SRS resource set IDs, or both).

In some cases, the UE 115-a may transmit a report 230 indicating one or more capabilities of the UE 115-a to communicate the reference signals 225. For example, the report 230 may indicate a quantity of SRS resources (e.g., a maximum quantity) associated with each SRS resource set configured with the usage mode, a capability of the UE 115-a to support multi-port SRS resources, a quantity of antenna ports associated with the UE 115-a for communicating the multi-port SRS resources, a quantity of SRS resources that are actively transmitted, a quantity of SRS ports that are actively transmitted, or a combination thereof. In some examples, the mapping between the reference signals 225 and the receive beams 205, as well as the capabilities of the UE 115-a, may be associated with a frequency band, a serving cell, a BWP, or any combination thereof.

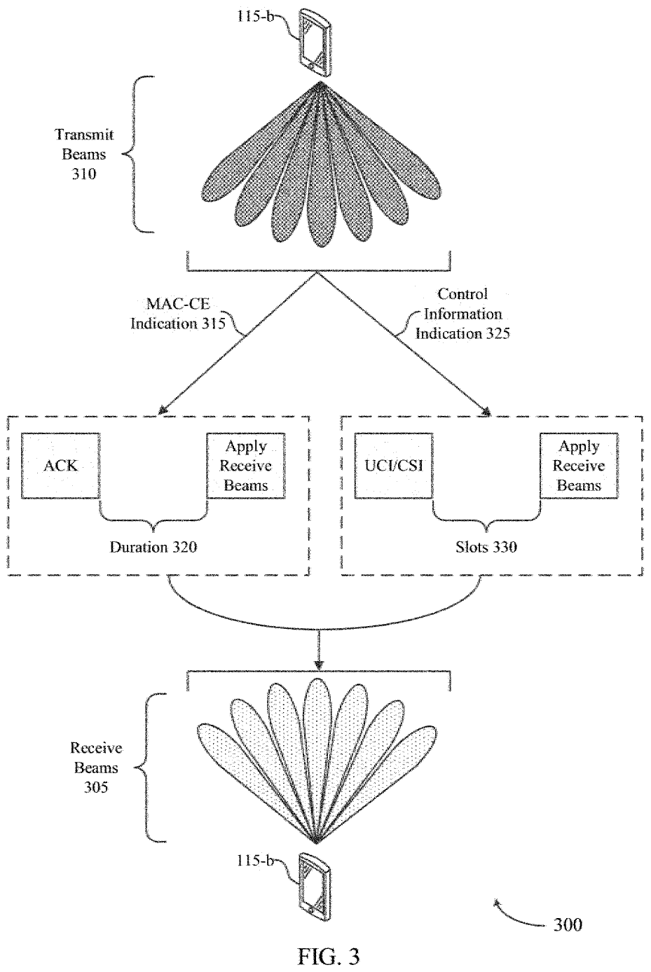

In a second example, the mapping between the reference signals 225 and the receive beams 205 may be based on dynamic updates from the UE 115-a. For example, the UE 115-a may transmit, to the network entity 105-a, an update message 235 indicating SRS resources actively transmitted by the UE 115-a. The update message 235 may be a MAC-CE, an uplink control information (UCI) message, a channel station information (CSI) message, or a combination thereof. Such techniques are described in more detail with reference to FIG. 3.

In some examples, the UE 115-a may indicate a receive beam 205 by indicating one or more SRS resources as part of a measurement report (e.g., in the update message 235). For example, the UE 115-a may receive, from the network entity 105-a, a channel measurement resource (CMR) and may measure the CMR using at least one receive beam 205. In some cases, the UE 115-a may generate a measurement report, which may include the CMR measurement (e.g., a L1 reference signal receive power (L1-RSRP) measurement or a L1 signal-to-interference and noise ratio (L1-SINR) measurement) and may include one or more SRS resource IDs associated with the at least one receive beam 205, one or more SRS resource set IDs, or an ID of the at least one receive beam 205 in the measurement report. In some cases, the UE 115-a may identify a parameter associated with a CSI report setting (e.g., ReportQuantity), and may use the parameter to indicate additional information (e.g., SRS resource IDs or receive beam ID) in the CSI report. In such cases, the UE 115-a may report, to the network entity 105-a, a capability of the UE 115-a to support measurement reports which include the additional information.

The UE 115-a may include an explicit indication of an SRS resource ID with the measurement report. As an example, if the reference signals 225 are associated with multiple SRS resource sets, the UE 115-a may indicate an SRS resource set ID and SRS resource ID (e.g., with receive beams 205 indexed first by SRS resource set ID ordering and then by SRS resource ID ordering). If the reference signals 225 are associated with a single SRS resource set, the UE 115-a may indicate an SRS resource ID associated with the SRS resource (e.g., associated with receive beam 205 used to measure the CMR 237). Additionally, or alternatively, the UE 115-a may indicate that the receive beam 205 used for measuring the CMR 237 is based on a spatial transmission filter associated with a transmit beam 210 that the UE 115-a used to transmit the corresponding SRS resource in a most recent transmission occasion. For example, the network entity 105-a may determine the receive beam information for the receive beam 205 according to the indicated SRS resource ID (e.g., corresponding to the receive beam 205) and the spatial transmission filter applied to a most recent transmission of the SRS resource associated with the SRS resource ID. As another example, the UE 115-a may implicitly indicate the SRS resource associated with the receive beam 205 by indicating an ID of the receive beam 205. For example, the UE 115-a may indicate the ID of the receive beam 205 used to measure the CMR 237, which may support the network entity 105-a identifying corresponding candidate receive beams 205 according to the mapping rules (e.g., a predefined mapping, a preconfigured mapping, a dynamically updated mapping by the UE 115-a, or any combination thereof).

In some cases, the network entity 105-a may transmit, to the UE 115-a, instructions 240 for receiving one or more messages from the network entity 105-a (e.g., PDSCH messages or PDCCH messages). For example, after receiving the reference signals 225, the network entity 105-a may transmit the instructions 240, which may indicate an SRS resource of the one or more SRS resource sets associated with the reference signals 225. In some cases, such as when the reference signals 225 are associated with one SRS resource set, the network entity 105-a may indicate an SRS resource ID associated with the SRS resource. In some other cases, such as when the reference signals 225 are associated with multiple SRS resource sets, the network entity 105-a may indicate the SRS resource ID and an SRS resource set ID associated with an SRS resource set that includes the SRS resource. Additionally, or alternatively, the network entity 105-a may indicate that a receive beam 205 that UE 115-a is to use for receiving the one or more messages is based on a spatial transmission filter associated with a transmit beam 210 that the UE 115-a used to transmit the SRS resource (e.g., corresponding to the receive beam 205) in a most recent transmission occasion. In some cases, the network entity 105-a may indicate an ID of the receive beam 205, which may support the UE 115-a identifying corresponding candidate receive beams 205 according to the mapping rules (e.g., a predefined mapping, a preconfigured mapping, a dynamically updated mapping by the UE 115-a, or any combination thereof).

In some cases, the network entity 105-a may indicate the instructions 240 using various signaling techniques. In a first example, the network entity 105-a may transmit RRC signaling indicating a TCI (TCI) state for the UE 115-a, and may indicate the instructions 240 in the RRC signaling. In a second example, the network entity 105-a may transmit a MAC-CE activating a TCI state for the UE 115-a, and may indicate the instructions 240 in the MAC-CE. In a third example, the network entity 105-a may transmit a DCI including a command to switch a TCI state for the UE 115-a, and may indicate the instructions 240 in the DCI. In a fourth example, the network entity 105-a may transmit an indication of quasi-co-location (QCL) information for receiving signaling (e.g., PDCCH signaling or a control resource set (CORESET)), and may include the instructions 240 in the indication (e.g., via RRC configuration or a dedicated MAC-CE).

FIG. 3 illustrates an example of a mapping diagram 300 that supports beam pair prediction based on receive beam in accordance with one or more aspects of the present disclosure. The mapping diagram 300 may be implemented by one or more aspects of the wireless communications system 100 and the wireless communications system 200. For example, the mapping diagram 300 may be implemented by a UE 115-b to support dynamically updating a mapping between receive beams 305 of the UE 115-b and SRS resources communicated by the UE 115-b, which may be an example of the UE 115-a described with reference to FIG. 2.

In some cases, the UE 115-b may transmit one or more reference signals via one or more SRS resources of one or more SRS resource sets. For example, the UE 115-b may transmit SRS resources of a same SRS resource set or may transmit SRS resources of multiple SRS resource sets using transmit beams 310 of the UE 115-b. In some cases, the SRS resources may correspond to the receive beams 305 according to one or more mapping rules. The UE 115-b may indicate the one or more mapping rules by dynamically indicating SRS resources that are actively transmitted by the UE 115-b and a usage mode associated with SRS resource sets including the SRS resources. For example, the UE 115-b may indicate SRS resources of SRS resource sets that are configured with a first usage mode associated with reference signal transmission (e.g., a conventional usage mode). As another example, the UE 115-b may indicate SRS resources of SRS resource sets that are configured with a second usage mode associated with mapping SRS resources of the SRS resource sets to the receive beams 305 (e.g., usage=RxBeamIdentification).

In some cases, the UE 115-b may indicate one or more SRS resource IDs associated with the SRS resources, one or more SRS resource set IDs associated with the SRS resource sets, or both to a network entity 105 to support the network entity 105 determining receive beam information associated with the receive beams 305. For example, if the UE 115-b indicates SRS resources from a same SRS resource set, the UE 115-b may indicate the one or more SRS resource IDs and candidate receive beams 305 may be indexed according to an ordering of the SRS resource IDs. In some other examples, such as when the indicates SRS resources from multiple SRS resource sets, the UE 115-b may indicate the one or more SRS resource set IDs and the one or more SRS resource IDs, such that candidate receive beams 305 may be indexed according to an ordering of the SRS resource set IDs followed by an ordering of the SRS resource IDs.

In some cases, the UE 115-b may indicate the SRS resources via a MAC-CE indication 315. The UE 115-b may transmit the MAC-CE indication 315 to the network entity 105 and may receive a feedback message from the network entity 105 (e.g., a HARQ-ACK). In some cases, the UE 115-b may apply the receive beams 305 associated with the SRS resources after a duration 320, which may correspond to a quantity of milliseconds (e.g., X ms) after receiving the feedback message. In some cases, a quantity of receive beams 305 (e.g., a total number of receive beams per report) may be indicated by the MAC-CE indication 315 and may be based on a predefined value or may be based on a serving cell or BWP associated with the UE 115-b. For example, the total number of receive beams 305 indicatable per MAC-CE indication 315 may be predefined or configured (e.g., by network entity 105) on a per serving cell or BWP basis.

In some cases, the UE 115-b may indicate the SRS resources via a control information indication 325. In some cases, the control information indication 325 may be an UCI message or a CSI report (e.g., a semi-persistent CSI or an aperiodic CSI report). The UE 115-b may transmit the control information indication 325 to the network entity 105 and may apply the receive beams 305 associated with the SRS resources after transmitting the control information indication 325 according to a quantity of slots 330 (e.g., Y slots, which may be a predefined quantity of slots). In some cases, a quantity of receive beams 305 that may be indicated by the control information indication 325 may be a predefined value or may be configured by the network entity 105 (e.g., via a CSI report setting, a MAC-CE activating a semi-persistent CSI report, or an information element associated with an aperiodic CSI report, such as via CSI-AssociatedReportConfigInfo).

In some cases, parameters associated with the receive beams 305 (e.g., a pointing direction or beamwidth) may be associated with an SRS resource indicated in a most recent dynamic update (e.g., via the MAC-CE indication 315 or the control information indication 325). For example, the UE 115-b may indicate an SRS resource corresponding to a receive beam 305, and may configure the receive beams 205 with multiple pointing directions or beamwidths for one or more SRS occasions before a next dynamic update (e.g., corresponding to spatial filters associated with transmit beams 310 for each SRS occasion). As another example, the UE 115-b may indicate an SRS resource corresponding to a receive beam 305, and may apply a spatial transmission filter used for transmitting the SRS during a most recent SRS occasion to the receive beams 305 for each SRS occasion before a next dynamic update (e.g., a same pointing direction or beamwidth for each intermediate SRS occasion independent of spatial transmission filters applied for the intermediate SRS occasions).

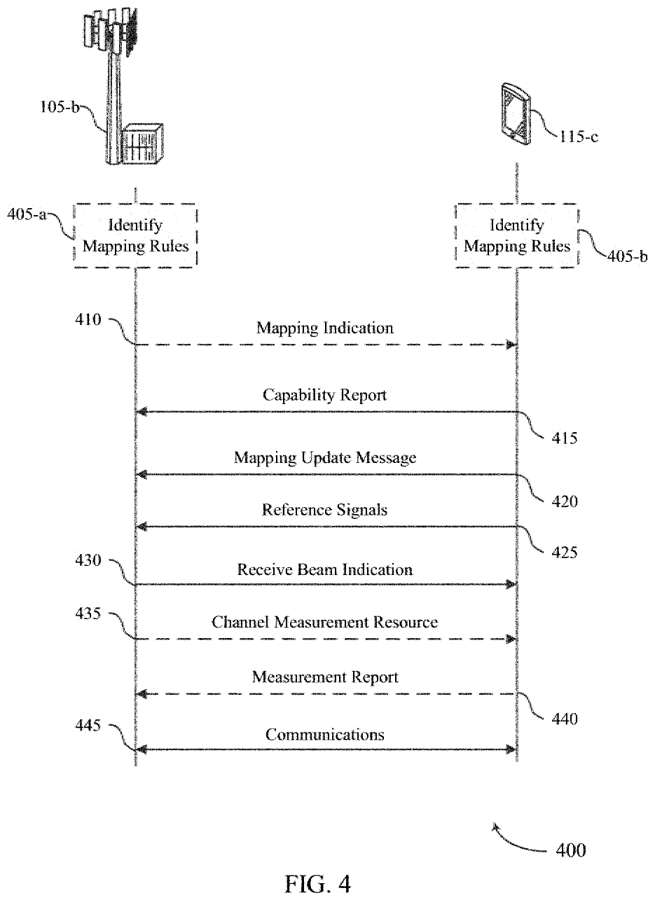

FIG. 4 illustrates an example of a process flow 400 that supports beam pair prediction based on receive beam in accordance with one or more aspects of the present disclosure. The process flow 400 may be implemented by one or more aspects of the wireless communications system 100 and the wireless communications system 200. For example, the process flow 400 may include signaling between a network entity 105-b and a UE 115-c to support indicating receive beam information of the UE 115-c according to SRS resources and SRS resource sets, which may be examples of the UE 115-a and the network entity 105-a described with respect to FIG. 2. Alternative examples of the following may be implemented, where some processes are performed in a different order than described or are not performed. In some cases, processes may include additional features not mentioned below, or further processes may be added.

At 405-a and 405-b, the network entity 105-b and the UE 115-c may, respectively, identify one or more mapping rules for associating SRS resources with one or more receive beams of the UE 115-c. For example, the one or more mapping rules may be predefined (e.g., defined in a standard), and the network entity 105-b and the UE 115-c may each identify the one or more mapping rules.

At 410, the network entity 105-b may transmit a mapping indication including one or more mapping rules for associating SRS resources with one or more receive beams of the UE 115-c. For example, the network entity 105-b may transmit an RRC message configuring the UE 115-c with the one or more mapping rules (e.g., preconfigured mapping rules). In some cases, the mapping rules may configure one or more SRS resource sets of a set of multiple SRS resource sets associated with the UE 115-c with a first usage mode (e.g., usage=RxBeamIdentification), where the first usage mode may indicate that the one or more SRS resource sets correspond to the receive beams of the UE 115-c.

At 415, the UE 115-c may transmit a capability report to the network entity 105-b. In some cases, the capability report may indicate one or more capabilities of the UE 115-c, where the one or more capabilities may include a first quantity of SRS resources associated with each SRS resource set of multiple SRS resource sets, a capability to support communication of one or more SRSs via multiple antenna ports associated with the UE 115-c, a second quantity of antenna ports of the multiple antenna ports associated with the first quantity of SRS resources of each SRS resource set of the one or more SRS resource sets, a second quantity of SRS resources associated with the one or more SRS resource sets, a third quantity of active antenna ports of the multiple antenna ports, or any combination thereof. In some cases, the mapping rules, the capability report, or both may be based on a frequency band associated with the one or more SRS resource sets, a serving cell associated with the one or more SRS resource sets, a BWP associated with the one or more SRS resource sets, or any combination thereof.

At 420, the UE 115-c may transmit a mapping update message (e.g., a dynamic update) to the network entity 105-b. In some cases, the mapping update message may indicate the one or more mapping rules for associating the one or more SRS resource sets with one or more receive beams of the UE 115-c. In some cases, the mapping update message may include one or more SRS resources of a first subset of the multiple SRS resource sets associated with the UE 115-c or one or more SRS resources of a second subset of the multiple SRS resource sets associated with the UE 115-c. In some examples, the first subset may indicate SRS resource sets configured with a second usage mode (e.g., allocated for reference signal transmission) and the second subset may indicate SRS resource sets configured with the first usage mode (e.g., allocated for beam identification usage).

In some cases, the UE 115-c may transmit the mapping update message via a MAC-CE indicating the one or more SRS resource sets, one or more SRS resources of the one or more SRS resource sets, or a combination thereof. In such an example, the UE 115-c may apply the receive beams indicated by the mapping update message after a time delay (e.g., X ms) after receiving a feedback message from the network entity 105-b for the mapping update message. In some other cases, the UE 115-c may transmit the mapping update message via a control signal (e.g., a UCI message or a CSI report) indicating the one or more SRS resource sets, one or more SRS resources of the one or more SRS resource sets, or a combination thereof. In such an example, the UE 115-c may apply the receive beams indicated by the mapping update message after a quantity of slots (e.g., Y slots, which may be a predefined value) after transmitting the mapping update message.

The UE 115-c may periodically transmit the mapping update message during one or more dynamic update occasions, and may apply a spatial transmission filter to the receive beams indicated by the mapping update message using various techniques. In a first example, the UE 115-c may apply a spatial filter to the receive beams that is associated with an SRS resource for each SRS occasion between dynamic update occasions (e.g., receiving signaling according to multiple pointing directions and multiple beamwidths based on the spatial filter associated with each transmission of the SRS resource). In a second example, the UE 115-c may apply a spatial filter to the receive beams that is associated with an SRS resource for a most recent SRS occasion prior to a dynamic update (e.g., receiving signaling according to a first pointing direction and a first beamwidth based on the spatial filter associated with one transmission of the SRS resource).

At 425, the UE 115-c may transmit one or more reference signals (e.g., SRSs) via the one or more SRS resource sets of the multiple SRS resource sets associated with the UE 115-c. In some cases, the SRSs may be transmitted via one or more SRS resources that indicate receive beams of the UE 115-c according to the one or more mapping rules. In some examples, the UE 115-c may index the receive beams according to an ordering that is based on one or more first IDs associated with the one or more SRS resource sets, one or more second IDs associated with the one or more SRS resources, or a combination thereof. For example, if the one or more SRS resources are associated with multiple SRS resource sets, the UE 115-c may first index the receive beams according to the one or more first IDs associated with the one or more SRS resource sets and may then index the receive beams according to the one or more second IDs associated with the one or more SRS resources.

At 430, the network entity 105-b may transmit a receive beam indication based on receiving the reference signals to support the UE 115-c receiving a PDSCH or a PDCCH message. In some cases, the receive beam indication may indicate an SRS resource (e.g., by an SRS resource ID) to the UE 115-c, which may indicate a receive beam of the UE 115-c according to the one or more mapping rules. In some cases, the receive beam indication may indicate one or more SRS resource set IDs (e.g., if the reference signals are associated with multiple SRS resource sets).

The network entity 105-b may transmit the receive beam indication using various signaling techniques. In a first example, the network entity 105-b may transmit RRC signaling indicating a TCI state for the UE 115-c, and may include the receive beam indication in the RRC signaling. In a second example, the network entity 105-b may transmit a MAC-CE activating a TCI state for the UE 115-c, and may include the receive beam indication in the MAC-CE. In a third example, the network entity 105-a may transmit a DCI including a command to switch a TCI state for the UE 115-c, and may include the receive beam indication in the DCI. In a fourth example, the network entity 105-a may transmit an indication of QCL information for receiving signaling (e.g., PDCCH signaling or a CORESET), and may include the receive beam indication in the indication (e.g., via RRC configuration or a dedicated MAC-CE).

At 435, the network entity 105-b may transmit a CMR to the UE 115-c. For example, the UE 115-c may monitor the CMR for a reference signal using at least on receive beam of the UE 115-c.

At 440, the UE 115-c may transmit a measurement report in response to receiving the CMR. For example, the UE 115-c may generate at least one reference signal measurement (e.g., a L1-RSRP or a L1-SINR) for the reference signal based on monitoring the CMR. The UE 115-c may transmit the measurement report indicating the at least one reference signal measurement and indicating at least one SRS resource that corresponds to the at least one receive beam used for monitoring the CMR (e.g., according to the one or more mapping rules. For example, the measurement report may include a first ID associated with the at least one SRS, a second ID associated with an SRS resource set for the UE 115-c (e.g., including the at least one SRS resource), a third ID associated with the at least one receive beam, a spatial filter associated with a transmit beam of the UE 115-c used to transmit the measurement report, or any combination thereof. Additionally, to support the measurement report, the UE 115-c may identify a parameter associated with a CSI report setting (e.g., ReportQuantity), and may enhance the parameter to support indicating additional information (e.g., SRS resource IDs or receive beam ID) in the measurement report. In such cases, the UE 115-c may report, to the network entity 105-b, a capability of the UE 115-c to support measurement reports which include the additional information.

At 445, the network entity 105-b and the UE 115-c may communicate according to the receive beam information indicated by the reference signals. For example, the UE 115-c may receive one or more messages using a receive beam of the one or more receive beams associated with the UE 115-c based on the receive beam information.

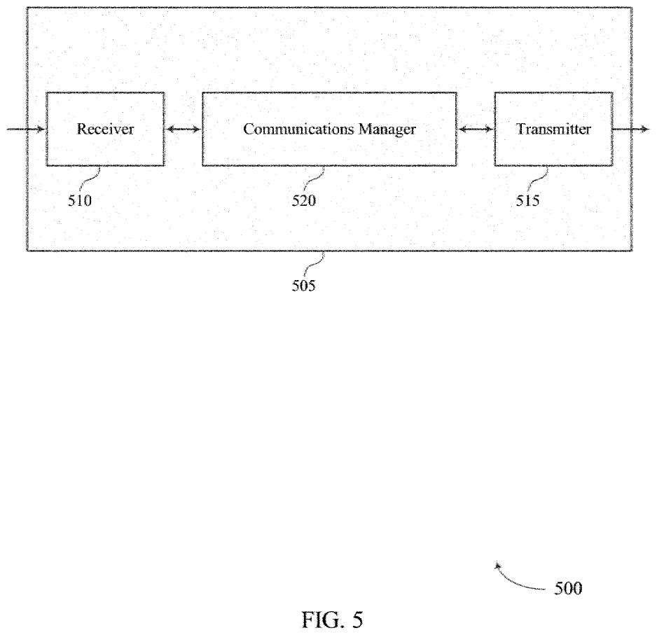

FIG. 5 illustrates a block diagram 500 of a device 505 that supports beam pair prediction based on receive beam in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to beam pair prediction based on receive beam). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to beam pair prediction based on receive beam). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of beam pair prediction based on receive beam as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The communications manager 520 may be configured as or otherwise support a means for receiving one or more messages using a receive beam of the one or more receive beams based on the receive beam information.

Additionally, or alternatively, the communications manager 520 may support wireless communication at a UE in accordance with examples as disclosed herein. For example, the communications manager 520 may be configured as or otherwise support a means for monitoring a CMR for a reference signal using at least one receive beam of a set of multiple receive beams of the UE. The communications manager 520 may be configured as or otherwise support a means for generating at least one reference signal measurement for the reference signal based on monitoring the CMR. The communications manager 520 may be configured as or otherwise support a means for transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced signaling overhead and avoiding the disclosure of proprietary UE information.

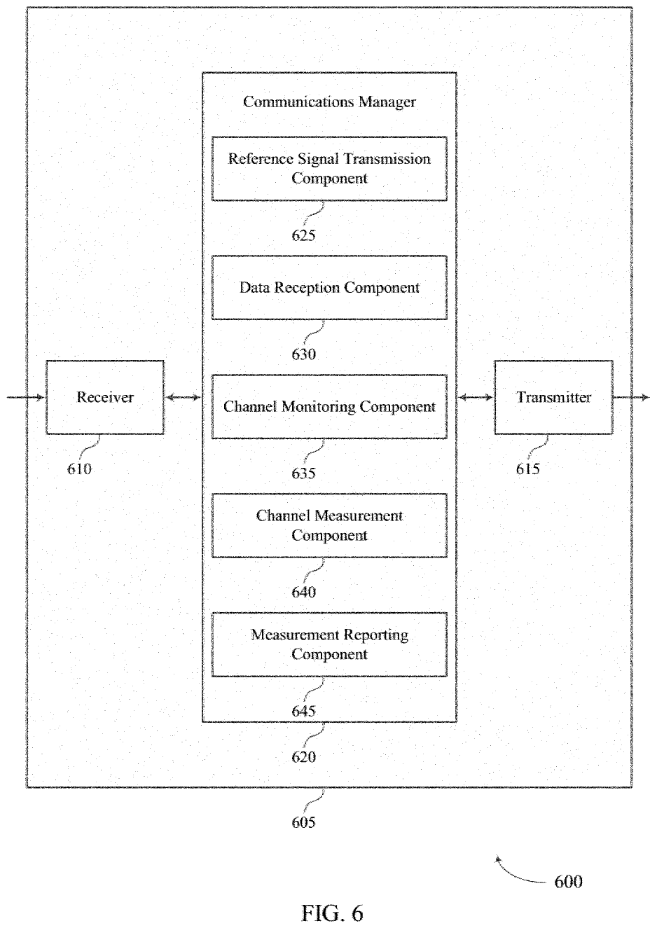

FIG. 6 illustrates a block diagram 600 of a device 605 that supports beam pair prediction based on receive beam in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to beam pair prediction based on receive beam). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to beam pair prediction based on receive beam). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of beam pair prediction based on receive beam as described herein. For example, the communications manager 620 may include a reference signal transmission component 625, a data reception component 630, a channel monitoring component 635, a channel measurement component 640, a measurement reporting component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The reference signal transmission component 625 may be configured as or otherwise support a means for transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The data reception component 630 may be configured as or otherwise support a means for receiving one or more messages using a receive beam of the one or more receive beams based on the receive beam information.

Additionally, or alternatively, the communications manager 620 may support wireless communication at a UE in accordance with examples as disclosed herein. The channel monitoring component 635 may be configured as or otherwise support a means for monitoring a CMR for a reference signal using at least one receive beam of a set of multiple receive beams of the UE. The channel measurement component 640 may be configured as or otherwise support a means for generating at least one reference signal measurement for the reference signal based on monitoring the CMR. The measurement reporting component 645 may be configured as or otherwise support a means for transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

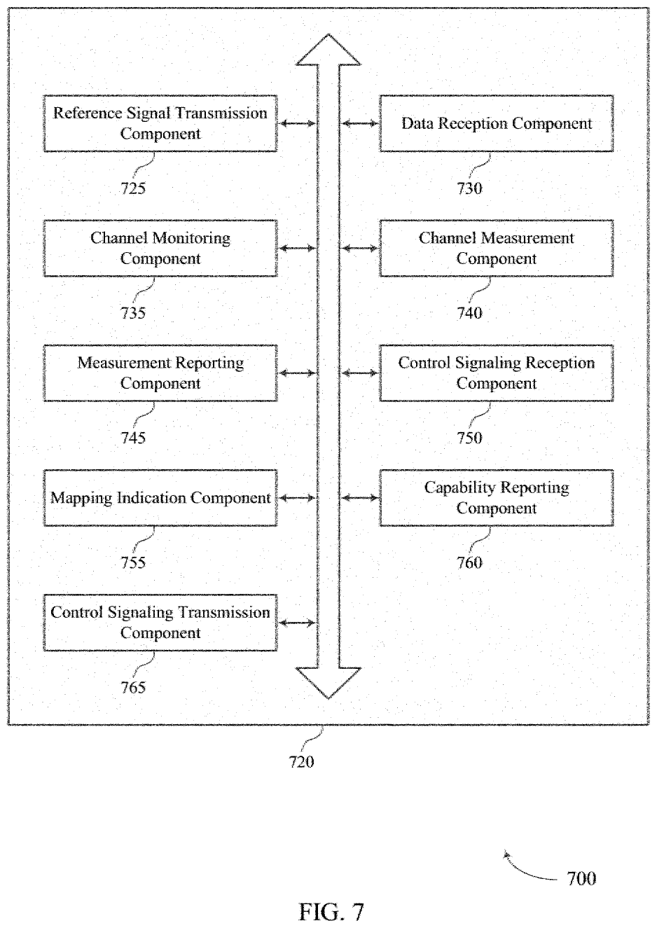

FIG. 7 illustrates a block diagram 700 of a communications manager 720 that supports beam pair prediction based on receive beam in accordance with one or more aspects of the present disclosure. The communications manager 720 may be an example of aspects of a communications manager 520, a communications manager 620, or both, as described herein. The communications manager 720, or various components thereof, may be an example of means for performing various aspects of beam pair prediction based on receive beam as described herein. For example, the communications manager 720 may include a reference signal transmission component 725, a data reception component 730, a channel monitoring component 735, a channel measurement component 740, a measurement reporting component 745, a control signaling reception component 750, a mapping indication component 755, a capability reporting component 760, a control signaling transmission component 765, or any combination thereof. Each of these components may communicate, directly or indirectly, with one another (e.g., via one or more buses).

The communications manager 720 may support wireless communication at a UE in accordance with examples as disclosed herein. The reference signal transmission component 725 may be configured as or otherwise support a means for transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The data reception component 730 may be configured as or otherwise support a means for receiving one or more messages using a receive beam of the one or more receive beams based on the receive beam information.

In some examples, the control signaling reception component 750 may be configured as or otherwise support a means for receiving RRC signaling indicating one or more rules for the mapping between the one or more resource sets and one or more receive beams of the UE, where transmitting the one or more reference signals is based at least in part on the RRC signaling and the one or more rules.

In some examples, to support transmitting the one or more reference signals via the one or more resource sets, the reference signal transmission component 725 may be configured as or otherwise support a means for transmitting the one or more reference signals via the one or more resource sets based on a rule for the mapping between the one or more resource sets and one or more receive beams of the UE.

In some examples, the mapping indication component 755 may be configured as or otherwise support a means for transmitting a message indicating one or more rules for the mapping between the one or more resource sets and one or more receive beams of the UE, where transmitting the one or more reference signals is based on the one or more rules.

In some examples, the message includes an indication of one or more resources of a first subset of the set of multiple resource sets or of a second subset of the set of multiple resource sets. In some examples, the first subset is allocated for reference signal transmission. In some examples, the second subset is allocated for beam identification usage.

In some examples, to support transmitting the message, the control signaling transmission component 765 may be configured as or otherwise support a means for transmitting a MAC-CE indicating the one or more resource sets or one or more resources of the one or more resource sets, where the one or more messages are received based on a time delay after acknowledgement of the MAC-CE.

In some examples, to support transmitting the message, the control signaling transmission component 765 may be configured as or otherwise support a means for transmitting UCI indicating the one or more resource sets or one or more resources of the one or more resource sets, where the one or more messages are received based on a quantity of slots after transmitting the UCI.

In some examples, the data reception component 730 may be configured as or otherwise support a means for receiving, based on transmitting the one or more reference signals, a message indicating at least one resource of the one or more resource sets, the at least one resource for reception of the one or more messages using the receive beam, where the one or more messages include a downlink shared channel, a downlink control channel, or a combination thereof.

In some examples, the message includes one or more first IDs associated with the at least one resource, one or more second IDs associated with the one or more resource sets, one or more third IDs associated with at least the receive beam, or any combination thereof.

In some examples, the one or more reference signals are associated with an ordering that is based on one or more first IDs associated with the one or more resource sets, one or more second IDs associated with one or more resources of the one or more resource sets, or any combination thereof.

In some examples, the capability reporting component 760 may be configured as or otherwise support a means for transmitting a capability report indicating one or more capabilities of the UE, the one or more capabilities including a first quantity of resources associated with each resource set of the set of multiple resource sets, a capability to support communication of the one or more reference signals via a set of multiple antenna ports associated with the UE, a second quantity of antenna ports of the set of multiple antenna ports associated with the first quantity of resources of each resource set of the one or more resource sets, a second quantity of resources associated with the one or more resource sets, a third quantity of active antenna ports of the set of multiple antenna ports, or any combination thereof, where transmitting the one or more reference signals is based on transmitting the capability report.

In some examples, the mapping between the one or more resource sets and the one or more receive beams of the UE is based on a frequency band associated with the one or more resource sets, a serving cell associated with the one or more resource sets, a BWP associated with the one or more resource sets, or any combination thereof.

In some examples, the mapping between the one or more resource sets and one or more receive beams of the UE is based on a usage mode associated with the one or more resource sets, the usage mode indicating that the set of multiple resource sets correspond to the set of multiple receive beams of the UE.

Additionally, or alternatively, the communications manager 720 may support wireless communication at a UE in accordance with examples as disclosed herein. The channel monitoring component 735 may be configured as or otherwise support a means for monitoring a CMR for a reference signal using at least one receive beam of a set of multiple receive beams of the UE. The channel measurement component 740 may be configured as or otherwise support a means for generating at least one reference signal measurement for the reference signal based on monitoring the CMR. The measurement reporting component 745 may be configured as or otherwise support a means for transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

In some examples, the measurement report includes a first ID associated with the at least one reference signal resource, a second ID associated with a resource set for the UE including the at least one reference signal resource, a third ID associated with the at least one receive beam, a spatial filter associated with a transmit beam of the UE used to transmit the measurement report, or any combination thereof.

In some examples, the capability reporting component 760 may be configured as or otherwise support a means for transmitting a capability report indicating a capability of the UE to report a quantity of receive beams associated with the at least one receive beam used to monitor the CMR, where the measurement report includes an indication of the quantity of receive beams.

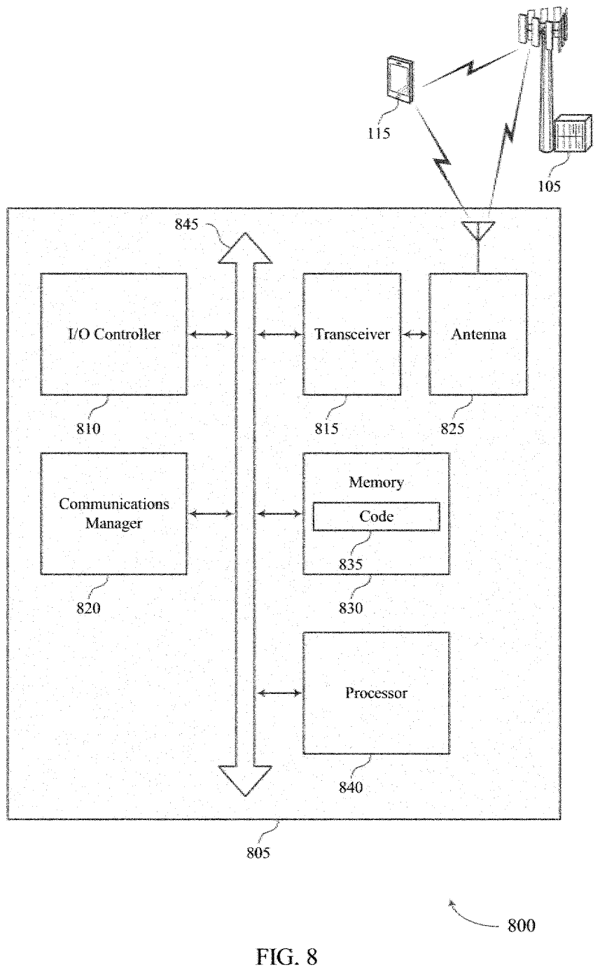

FIG. 8 illustrates a diagram of a system 800 including a device 805 that supports beam pair prediction based on receive beam in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting beam pair prediction based on receive beam). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The communications manager 820 may be configured as or otherwise support a means for receiving one or more messages using a receive beam of the one or more receive beams based on the receive beam information.

Additionally, or alternatively, the communications manager 820 may support wireless communication at a UE in accordance with examples as disclosed herein. For example, the communications manager 820 may be configured as or otherwise support a means for monitoring a CMR for a reference signal using at least one receive beam of a set of multiple receive beams of the UE. The communications manager 820 may be configured as or otherwise support a means for generating at least one reference signal measurement for the reference signal based on monitoring the CMR. The communications manager 820 may be configured as or otherwise support a means for transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE.

By including or configuring the communications manager 820 in accordance with examples as described herein, the device 805 may support techniques for reduced signaling overhead and avoiding the disclosure of proprietary UE information.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of beam pair prediction based on receive beam as described herein, or the processor 840 and the memory 830 may be otherwise configured to perform or support such operations.

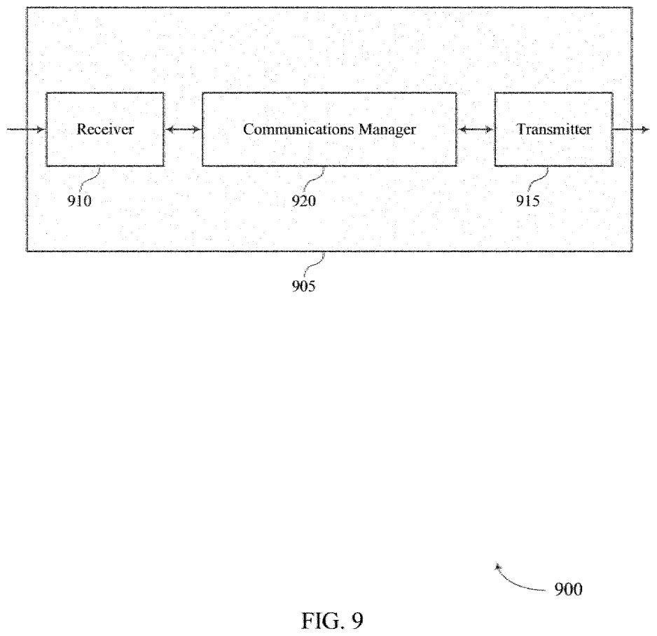

FIG. 9 illustrates a block diagram 900 of a device 905 that supports beam pair prediction based on receive beam in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of beam pair prediction based on receive beam as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The communications manager 920 may be configured as or otherwise support a means for transmitting one or more messages to the UE, the one or more messages indicating at least one of the one or more resource sets based on the receive beam information.

Additionally, or alternatively, the communications manager 920 may support wireless communications at a network entity in accordance with examples as disclosed herein. For example, the communications manager 920 may be configured as or otherwise support a means for transmitting one or more reference signals via one or more CMRs. The communications manager 920 may be configured as or otherwise support a means for receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced signaling overhead and avoiding the disclosure of proprietary UE information.

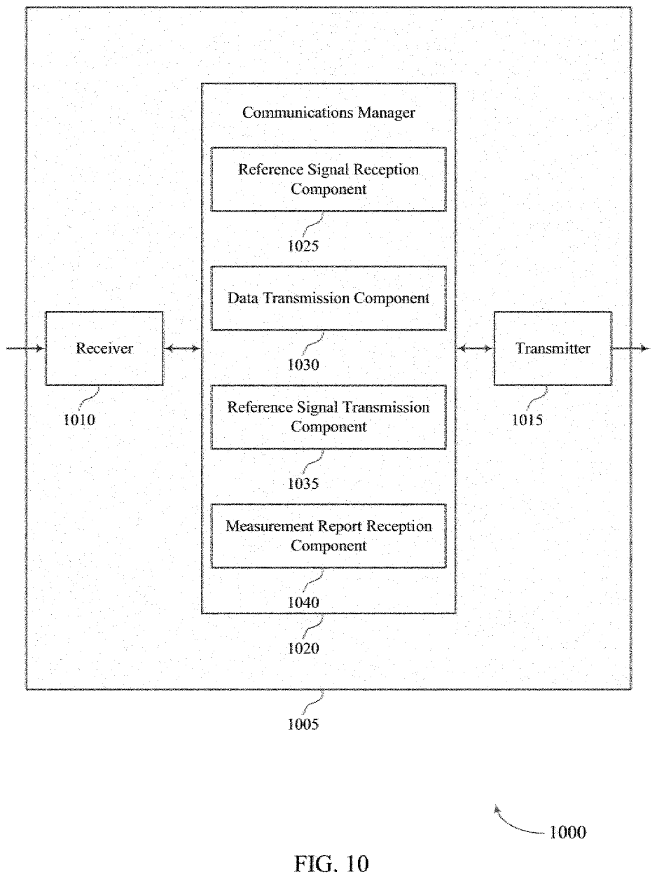

FIG. 10 illustrates a block diagram 1000 of a device 1005 that supports beam pair prediction based on receive beam in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of beam pair prediction based on receive beam as described herein. For example, the communications manager 1020 may include a reference signal reception component 1025, a data transmission component 1030, a reference signal transmission component 1035, a measurement report reception component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The reference signal reception component 1025 may be configured as or otherwise support a means for receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The data transmission component 1030 may be configured as or otherwise support a means for transmitting one or more messages to the UE, the one or more messages indicating at least one of the one or more resource sets based on the receive beam information.

Additionally, or alternatively, the communications manager 1020 may support wireless communications at a network entity in accordance with examples as disclosed herein. The reference signal transmission component 1035 may be configured as or otherwise support a means for transmitting one or more reference signals via one or more CMRs. The measurement report reception component 1040 may be configured as or otherwise support a means for receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

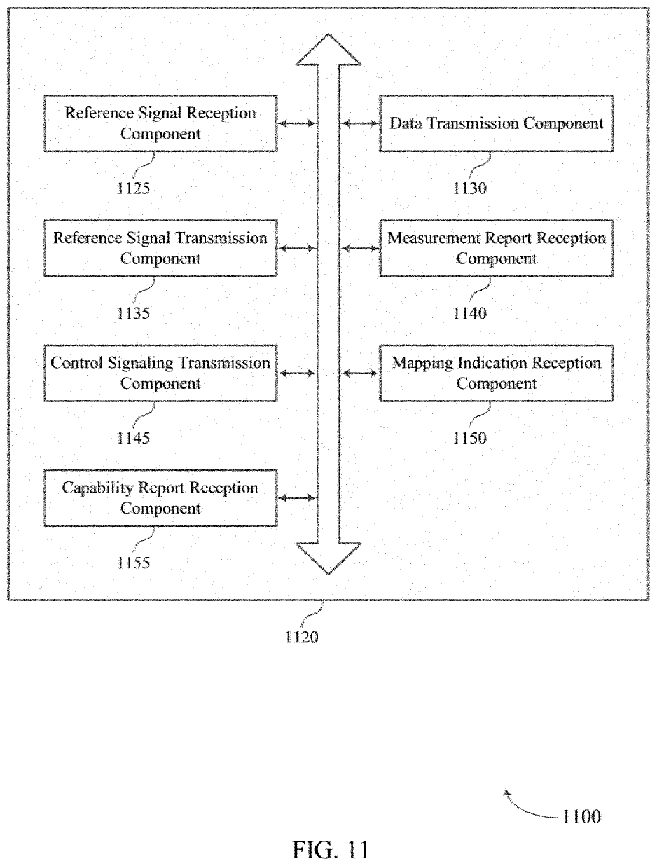

FIG. 11 illustrates a block diagram 1100 of a communications manager 1120 that supports beam pair prediction based on receive beam in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of beam pair prediction based on receive beam as described herein. For example, the communications manager 1120 may include a reference signal reception component 1125, a data transmission component 1130, a reference signal transmission component 1135, a measurement report reception component 1140, a control signaling transmission component 1145, a mapping indication reception component 1150, a capability report reception component 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The reference signal reception component 1125 may be configured as or otherwise support a means for receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The data transmission component 1130 may be configured as or otherwise support a means for transmitting one or more messages to the UE, the one or more messages indicating at least one of the one or more resource sets based on the receive beam information.

In some examples, the control signaling transmission component 1145 may be configured as or otherwise support a means for transmitting RRC signaling indicating one or more rules for the mapping between the one or more resource sets and one or more receive beams of the UE, where receiving the one or more reference signals is based on the RRC signaling and the one or more rules.

In some examples, to support receiving the one or more reference signals via the one or more resource sets, the reference signal reception component 1125 may be configured as or otherwise support a means for receiving the one or more reference signals via the one or more resource sets based on a rule for the mapping between the one or more resource sets and one or more receive beams of the UE.

In some examples, the mapping indication reception component 1150 may be configured as or otherwise support a means for receiving a message indicating the one or more rules for the mapping between the one or more resource sets and one or more receive beams of the UE, where receiving the one or more reference signals is based on the one or more rules.

In some examples, the message includes an indication of one or more resources of a first subset of the set of multiple resource sets or of a second subset of the set of multiple resource sets. In some examples, the first subset is allocated for reference signal transmission. In some examples, the second subset is allocated for beam identification usage.

In some examples, the data transmission component 1130 may be configured as or otherwise support a means for transmitting, based on receiving the one or more reference signals, a message indicating at least one resource of the one or more resource sets, the at least one resource for transmission of the one or more messages, where the one or more messages include a downlink shared channel, a downlink control channel, or a combination thereof.

In some examples, the one or more reference signals are associated with an ordering that is based on one or more first IDs associated with the one or more resource sets, one or more second indices associated with one or more resources of the one or more resource sets, or any combination thereof.

In some examples, the capability report reception component 1155 may be configured as or otherwise support a means for receiving a capability report indicating one or more capabilities of the UE, the one or more capabilities including a first quantity of resources associated with each resource set of the set of multiple resource sets, a capability to support communication of the one or more reference signals via a set of multiple antenna ports associated with the UE, a second quantity of antenna ports of the set of multiple antenna ports associated with the first quantity of resources of each resource set of the one or more resource sets, a second quantity of resources associated with the one or more resource sets, a third quantity of active antenna ports of the set of multiple antenna ports, or any combination thereof, where receiving the one or more reference signals is based on transmitting the capability report.

In some examples, the mapping between the one or more resource sets and the one or more receive beams of the UE is based on a frequency band associated with the one or more resource sets, a serving cell associated with the one or more resource sets, a BWP associated with the one or more resource sets, or a combination thereof.

Additionally, or alternatively, the communications manager 1120 may support wireless communications at a network entity in accordance with examples as disclosed herein. The reference signal transmission component 1135 may be configured as or otherwise support a means for transmitting one or more reference signals via one or more CMRs. The measurement report reception component 1140 may be configured as or otherwise support a means for receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

In some examples, the measurement report includes a first ID associated with the at least one reference signal resource, a second ID associated with a resource set for the UE including the at least one reference signal resource, a third ID associated with the at least one receive beam, a spatial filter associated with a transmit beam of the UE used to transmit the measurement report, or any combination thereof.

In some examples, the capability report reception component 1155 may be configured as or otherwise support a means for receiving a capability report indicating a capability of the UE to report a quantity of receive beams associated with the at least one receive beam used to monitor the CMR, where the measurement report includes an indication of the quantity of receive beams.

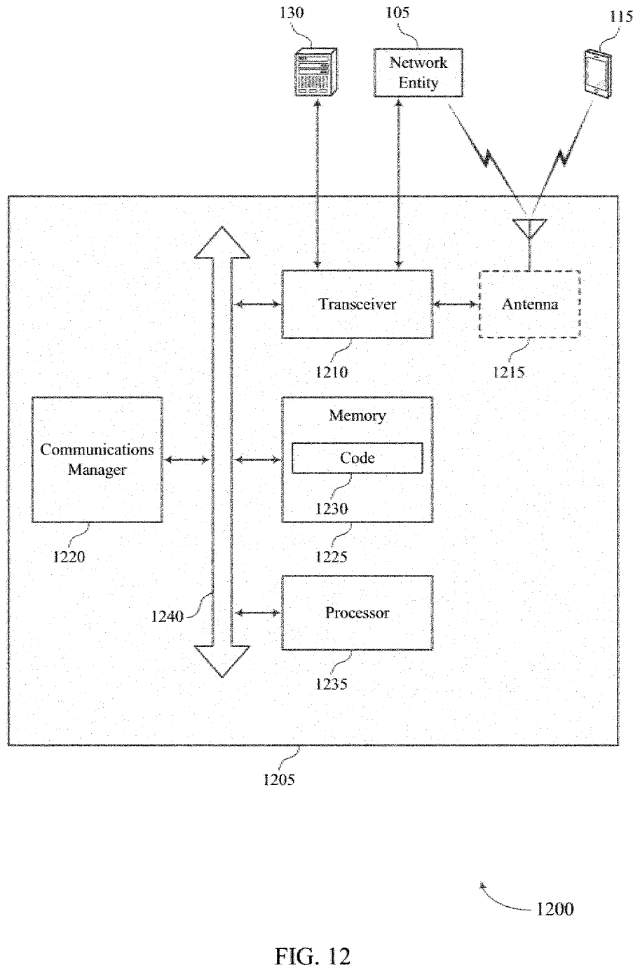

FIG. 12 illustrates a diagram of a system 1200 including a device 1205 that supports beam pair prediction based on receive beam in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting beam pair prediction based on receive beam). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The communications manager 1220 may be configured as or otherwise support a means for transmitting one or more messages to the UE, the one or more messages indicating at least one of the one or more resource sets based on the receive beam information.

Additionally, or alternatively, the communications manager 1220 may support wireless communications at a network entity in accordance with examples as disclosed herein. For example, the communications manager 1220 may be configured as or otherwise support a means for transmitting one or more reference signals via one or more CMRs. The communications manager 1220 may be configured as or otherwise support a means for receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE.

By including or configuring the communications manager 1220 in accordance with examples as described herein, the device 1205 may support techniques for reduced signaling overhead and avoiding the disclosure of proprietary UE information.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of beam pair prediction based on receive beam as described herein, or the processor 1235 and the memory 1225 may be otherwise configured to perform or support such operations.

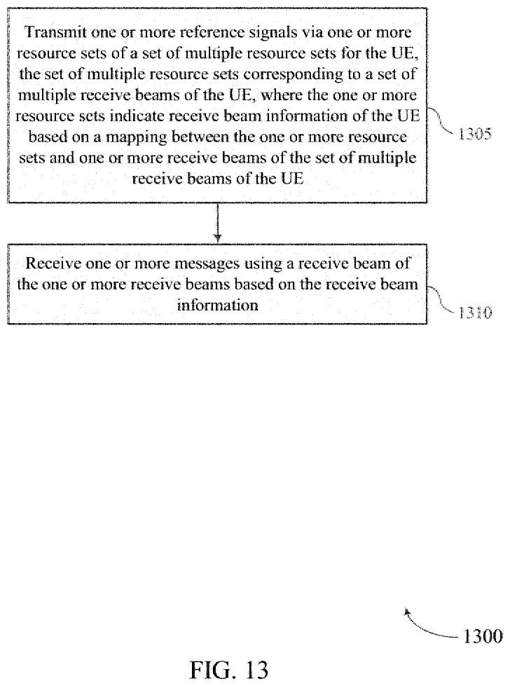

FIG. 13 illustrates a flowchart showing a method 1300 that supports beam pair prediction based on receive beam in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting one or more reference signals via one or more resource sets of a set of multiple resource sets for the UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The operations of 1305 may be performed in accordance with examples as disclosed herein. In some examples, aspects of the operations of 1305 may be performed by a reference signal transmission component 725 as described with reference to FIG. 7.

At 1310, the method may include receiving one or more messages using a receive beam of the one or more receive beams based on the receive beam information. The operations of 1310 may be performed in accordance with examples as disclosed herein. In some examples, aspects of the operations of 1310 may be performed by a data reception component 730 as described with reference to FIG. 7.

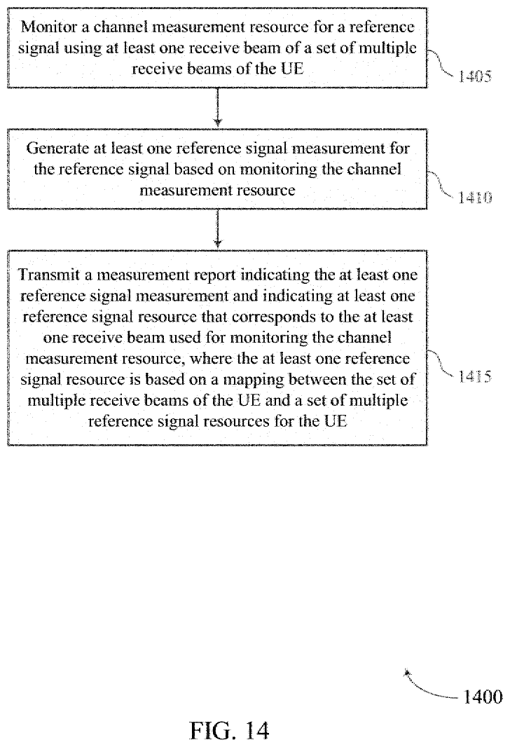

FIG. 14 illustrates a flowchart showing a method 1400 that supports beam pair prediction based on receive beam in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include monitoring a CMR for a reference signal using at least one receive beam of a set of multiple receive beams of the UE. The operations of 1405 may be performed in accordance with examples as disclosed herein. In some examples, aspects of the operations of 1405 may be performed by a channel monitoring component 735 as described with reference to FIG. 7.

At 1410, the method may include generating at least one reference signal measurement for the reference signal based on monitoring the CMR. The operations of 1410 may be performed in accordance with examples as disclosed herein. In some examples, aspects of the operations of 1410 may be performed by a channel measurement component 740 as described with reference to FIG. 7.

At 1415, the method may include transmitting a measurement report indicating the at least one reference signal measurement and indicating at least one reference signal resource that corresponds to the at least one receive beam used for monitoring the CMR, where the at least one reference signal resource is based on a mapping between the set of multiple receive beams of the UE and a set of multiple reference signal resources for the UE. The operations of 1415 may be performed in accordance with examples as disclosed herein. In some examples, aspects of the operations of 1415 may be performed by a measurement reporting component 745 as described with reference to FIG. 7.

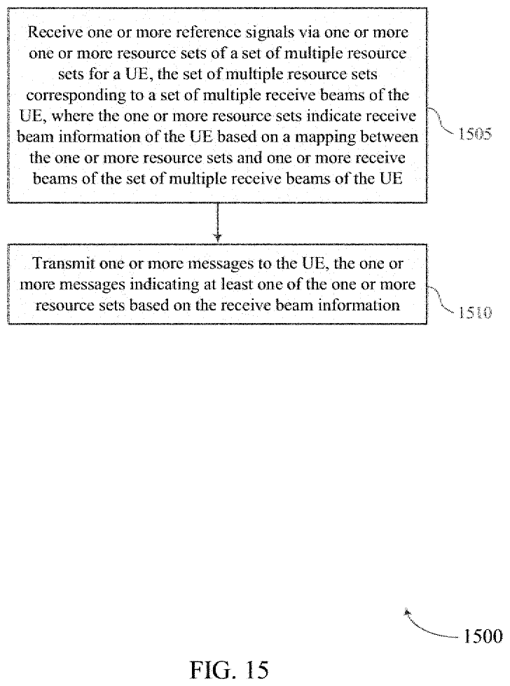

FIG. 15 illustrates a flowchart showing a method 1500 that supports beam pair prediction based on receive beam in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving one or more reference signals via one or more one or more resource sets of a set of multiple resource sets for a UE, the set of multiple resource sets corresponding to a set of multiple receive beams of the UE, where the one or more resource sets indicate receive beam information of the UE based on a mapping between the one or more resource sets and one or more receive beams of the set of multiple receive beams of the UE. The operations of 1505 may be performed in accordance with examples as disclosed herein. In some examples, aspects of the operations of 1505 may be performed by a reference signal reception component 1125 as described with reference to FIG. 11.

At 1510, the method may include transmitting one or more messages to the UE, the one or more messages indicating at least one of the one or more resource sets based on the receive beam information. The operations of 1510 may be performed in accordance with examples as disclosed herein. In some examples, aspects of the operations of 1510 may be performed by a data transmission component 1130 as described with reference to FIG. 11.

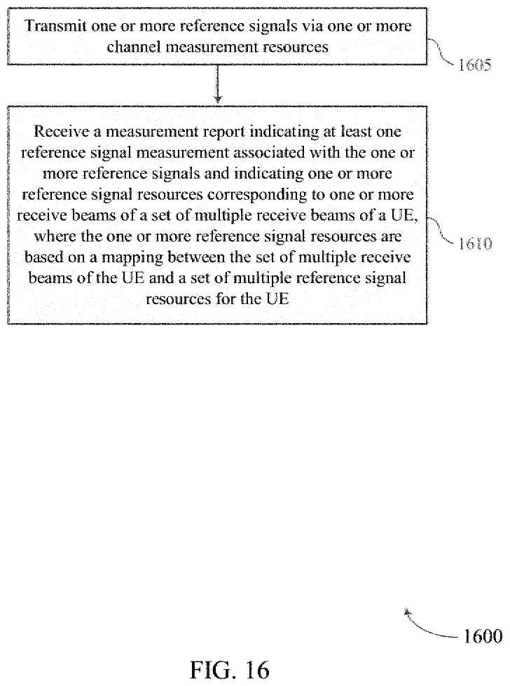

FIG. 16 illustrates a flowchart showing a method 1600 that supports beam pair prediction based on receive beam in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting one or more reference signals via one or more CMRs. The operations of 1605 may be performed in accordance with examples as disclosed herein. In some examples, aspects of the operations of 1605 may be performed by a reference signal transmission component 1135 as described with reference to FIG. 11.

At 1610, the method may include receiving a measurement report indicating at least one reference signal measurement associated with the one or more reference signals and indicating one or more reference signal resources corresponding to one or more receive beams of a set of multiple receive beams of a UE, where the one or more reference signal resources are based on a mapping between the set of multiple receive beams of the UE and a set of multiple reference signal resources for the UE. The operations of 1610 may be performed in accordance with examples as disclosed herein. In some examples, aspects of the operations of 1610 may be performed by a measurement report reception component 1140 as described with reference to FIG. 11.

The following provides an overview of aspects of the present disclosure:
Aspect 1: A method for wireless communication at a UE, comprising: transmitting one or more reference signals via one or more resource sets of a plurality of resource sets for the UE, the plurality of resource sets corresponding to a plurality of receive beams of the UE, wherein the one or more resource sets indicate receive beam information of the UE based at least in part on a mapping between the one or more resource sets and one or more receive beams of the plurality of receive beams of the UE; and receiving one or more messages using a receive beam of the one or more receive beams based at least in part on the receive beam information.
Aspect 2: The method of aspect 1, further comprising: receiving RRC signaling indicating one or more rules for the mapping between the one or more resource sets and one or more receive beams of the UE, wherein transmitting the one or more reference signals is based at least in part the RRC signaling and the one or more rules.
Aspect 3: The method of aspect 1, wherein transmitting the one or more reference signals via the one or more resource sets comprises: transmitting the one or more reference signals via the one or more resource sets based at least in part on a rule for the mapping between the one or more resource sets and one or more receive beams of the UE.
Aspect 4: The method of aspect 1, further comprising: transmitting a message indicating one or more rules for the mapping between the one or more resource sets and one or more receive beams of the UE, wherein transmitting the one or more reference signals is based at least in part on the one or more rules.
Aspect 5: The method of aspect 4, wherein the message comprises an indication of one or more resources of a first subset of the plurality of resource sets or of a second subset of the plurality of resource sets, the first subset is allocated for reference signal transmission, and the second subset is allocated for beam identification usage.
Aspect 6: The method of any of aspects 4 through 5, wherein transmitting the message comprises: transmitting a MAC-CE indicating the one or more resource sets or one or more resources of the one or more resource sets, wherein the one or more messages are received based at least in part on a time delay after acknowledgement of the MAC-CE.
Aspect 7: The method of any of aspects 4 through 6, wherein transmitting the message comprises: transmitting UCI indicating the one or more resource sets or one or more resources of the one or more resource sets, wherein the one or more messages are received based at least in part on a quantity of slots after transmitting the UCI.
Aspect 8: The method of any of aspects 4 through 7, wherein the message comprises an indication of at least a first resource associated with the one or more resource sets that corresponds to at least the receive beam, further comprising: receiving the one or more messages in accordance with a plurality of pointing directions associated with the receive beam and a plurality of beamwidths associated with the receive beam; or receiving the one or more messages in accordance with a first pointing direction associated with the receive beam and a first beamwidth associated with the receive beam, the first pointing direction and the first beamwidth based at least in part on a spatial filter associated with a transmit beam of the UE used to transmit one or more reference signals.
Aspect 9: The method of any of aspects 1 through 8, further comprising: receiving, based at least in part on transmitting the one or more reference signals, a message indicating at least one resource of the one or more resource sets, the at least one resource for reception of the one or more messages using the receive beam, wherein the one or more messages comprise a downlink shared channel, a downlink control channel, or a combination thereof.
Aspect 10: The method of aspect 9, wherein the message comprises one or more first IDs associated with the at least one resource, one or more second IDs associated with the one or more resource sets, one or more third IDs associated with at least the receive beam, or any combination thereof.
Aspect 11: The method of any of aspects 9 through 10, wherein the message comprises: a RRC message indicating a TCI state for the UE; a MAC-CE indicating an activation of the TCI state of the UE; a DCI message indicating a command to switch from a first transmission indicator state of the UE to a second transmission indicator state of the UE; or an indication of QCL information for receiving the one or more messages.
Aspect 12: The method of any of aspects 1 through 11, wherein the one or more reference signals are associated with an ordering that is based at least in part on one or more first IDs associated with the one or more resource sets, one or more second IDs associated with one or more resources of the one or more resource sets, or any combination thereof.
Aspect 13: The method of any of aspects 1 through 12, further comprising: transmitting a capability report indicating one or more capabilities of the UE, the one or more capabilities comprising a first quantity of resources associated with each resource set of the plurality of resource sets, a capability to support communication of the one or more reference signals via a plurality of antenna ports associated with the UE, a second quantity of antenna ports of the plurality of antenna ports associated with the first quantity of resources of each resource set of the one or more resource sets, a second quantity of resources associated with the one or more resource sets, a third quantity of active antenna ports of the plurality of antenna ports, or any combination thereof, wherein transmitting the one or more reference signals is based at least in part on transmitting the capability report.
Aspect 14: The method of any of aspects 1 through 13, wherein the mapping between the one or more resource sets and the one or more receive beams of the UE is based at least in part on a frequency band associated with the one or more resource sets, a serving cell associated with the one or more resource sets, a bandwidth part associated with the one or more resource sets, or any combination thereof.
Aspect 15: The method of any of aspects 1 through 14, wherein the mapping between the one or more resource sets and one or more receive beams of the UE is based at least in part on a usage mode associated with the one or more resource sets, the usage mode indicating that the plurality of resource sets correspond to the plurality of receive beams of the UE.
Aspect 16: A method for wireless communication at a UE, comprising: monitoring a CMR for a reference signal using at least one receive beam of a plurality of receive beams of the UE; generating at least one reference signal measurement for the reference signal based at least in part on monitoring the CMR; and transmitting a measurement report indicating the at least one reference signal measurement and indicating at least one reference signal resource that corresponds to the at least one receive beam used for monitoring the CMR, wherein the at least one reference signal resource is based at least in part on a mapping between the plurality of receive beams of the UE and a plurality of reference signal resources for the UE.
Aspect 17: The method of aspect 16, wherein the measurement report comprises a first ID associated with the at least one reference signal resource, a second ID associated with a resource set for the UE comprising the at least one reference signal resource, a third ID associated with the at least one receive beam, a spatial filter associated with a transmit beam of the UE used to transmit the measurement report, or any combination thereof.
Aspect 18: The method of any of aspects 16 through 17, further comprising: transmitting a capability report indicating a capability of the UE to report a quantity of receive beams associated with the at least one receive beam used to monitor the CMR, wherein the measurement report comprises an indication of the quantity of receive beams.
Aspect 19: A method for wireless communication at a network entity, comprising: receiving one or more reference signals via one or more one or more resource sets of a plurality of resource sets for a UE, the plurality of resource sets corresponding to a plurality of receive beams of the UE, wherein the one or more resource sets indicate receive beam information of the UE based at least in part on a mapping between the one or more resource sets and one or more receive beams of the plurality of receive beams of the UE; and transmitting one or more messages to the UE, the one or more messages indicating at least one of the one or more resource sets based at least in part on the receive beam information.
Aspect 20: The method of aspect 19, further comprising: transmitting RRC signaling indicating one or more rules for the mapping between the one or more resource sets and one or more receive beams of the UE, wherein receiving the one or more reference signals is based at least in part on the RRC signaling and the one or more rules.
Aspect 21: The method of aspect 19, wherein receiving the one or more reference signals via the one or more resource sets comprises: receiving the one or more reference signals via the one or more resource sets based at least in part on a rule for the mapping between the one or more resource sets and one or more receive beams of the UE.
Aspect 22: The method of aspect 19, further comprising: receiving a message indicating the one or more rules for the mapping between the one or more resource sets and one or more receive beams of the UE, wherein receiving the one or more reference signals is based at least in part on the one or more rules.
Aspect 23: The method of aspect 22, wherein the message comprises an indication of one or more resources of a first subset of the plurality of resource sets or of a second subset of the plurality of resource sets, the first subset is allocated for reference signal transmission, and the second subset is allocated for beam identification usage.
Aspect 24: The method of any of aspects 19 through 23, further comprising: transmitting, based at least in part on receiving the one or more reference signals, a message indicating at least one resource of the one or more resource sets, the at least one resource for transmission of the one or more messages, wherein the one or more messages comprise a downlink shared channel, a downlink control channel, or a combination thereof.
Aspect 25: The method of any of aspects 19 through 24, wherein the one or more reference signals are associated with an ordering that is based at least in part on one or more first IDs associated with the one or more resource sets, one or more second indices associated with one or more resources of the one or more resource sets, or any combination thereof.
Aspect 26: The method of any of aspects 19 through 25, further comprising: receiving a capability report indicating one or more capabilities of the UE, the one or more capabilities comprising a first quantity of resources associated with each resource set of the plurality of resource sets, a capability to support communication of the one or more reference signals via a plurality of antenna ports associated with the UE, a second quantity of antenna ports of the plurality of antenna ports associated with the first quantity of resources of each resource set of the one or more resource sets, a second quantity of resources associated with the one or more resource sets, a third quantity of active antenna ports of the plurality of antenna ports, or any combination thereof, wherein receiving the one or more reference signals is based at least in part on transmitting the capability report.
Aspect 27: The method of any of aspects 19 through 26, wherein the mapping between the one or more resource sets and the one or more receive beams of the UE is based at least in part on a frequency band associated with the one or more resource sets, a serving cell associated with the one or more resource sets, a bandwidth part associated with the one or more resource sets, or a combination thereof.
Aspect 28: A method for wireless communications at a network entity, comprising: transmitting one or more reference signals via one or more CMRs; and receiving a measurement report indicating at least one reference signal measurement associated with the one or more reference signals and indicating one or more reference signal resources corresponding to one or more receive beams of a plurality of receive beams of a UE, wherein the one or more reference signal resources are based at least in part on a mapping between the plurality of receive beams of the UE and a plurality of reference signal resources for the UE.
Aspect 29: The method of aspect 28, wherein the measurement report comprises a first ID associated with the at least one reference signal resource, a second ID associated with a resource set for the UE comprising the at least one reference signal resource, a third ID associated with the at least one receive beam, a spatial filter associated with a transmit beam of the UE used to transmit the measurement report, or any combination thereof.
Aspect 30: The method of any of aspects 28 through 29, further comprising: receiving a capability report indicating a capability of the UE to report a quantity of receive beams associated with the at least one receive beam used to monitor the CMR, wherein the measurement report comprises an indication of the quantity of receive beams.
Aspect 31: An apparatus for wireless communication at a UE, comprising a memory; and a processor coupled to the memory and configured to perform a method of any of aspects 1 through 15.
Aspect 32: An apparatus for wireless communication at a UE, comprising at least one means for performing a method of any of aspects 1 through 15.
Aspect 33: A non-transitory computer-readable medium storing code for wireless communication at a UE, the code comprising instructions executable by a processor to perform a method of any of aspects 1 through 15.
Aspect 34: An apparatus for wireless communication at a UE, comprising a memory; a processor coupled to the memory and configured to perform a method of any of aspects 16 through 18.
Aspect 35: An apparatus for wireless communication at a UE, comprising at least one means for performing a method of any of aspects 16 through 18.
Aspect 36: A non-transitory computer-readable medium storing code for wireless communication at a UE, the code comprising instructions executable by a processor to perform a method of any of aspects 16 through 18.
Aspect 37: An apparatus for wireless communication at a network entity, comprising a memory; a processor coupled to the memory and configured to perform a method of any of aspects 19 through 27.
Aspect 38: An apparatus for wireless communication at a network entity, comprising at least one means for performing a method of any of aspects 19 through 27.
Aspect 39: A non-transitory computer-readable medium storing code for wireless communication at a network entity, the code comprising instructions executable by a processor to perform a method of any of aspects 19 through 27.
Aspect 40: An apparatus for wireless communications at a network entity, comprising a memory; a processor coupled to the memory and configured to perform a method of any of aspects 28 through 30.
Aspect 41: An apparatus for wireless communications at a network entity, comprising at least one means for performing a method of any of aspects 28 through 30.
Aspect 42: A non-transitory computer-readable medium storing code for wireless communications at a network entity, the code comprising instructions executable by a processor to perform a method of any of aspects 28 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor coupled to the memory and configured to:
transmit one or more reference signals via one or more resource sets of a plurality of resource sets for the UE, the plurality of resource sets corresponding to a plurality of receive beams of the UE, wherein the one or more resource sets indicate receive beam information of the UE based at least in part on a mapping between the one or more resource sets and one or more receive beams of the plurality of receive beams of the UE; and
receive one or more messages using a receive beam of the one or more receive beams based at least in part on the receive beam information.

2. The apparatus of claim 1, wherein the processor is further configured to:
receive radio resource control signaling indicating one or more rules for the mapping between the one or more resource sets and one or more receive beams of the UE, wherein transmitting the one or more reference signals is based at least in part on the radio resource control signaling and the one or more rules.

3. The apparatus of claim 1, wherein, to transmit the one or more reference signals via the one or more resource sets, the processor is configured to:
transmit the one or more reference signals via the one or more resource sets based at least in part on a rule for the mapping between the one or more resource sets and one or more receive beams of the UE.

4. The apparatus of claim 1, wherein the processor is further configured to:
transmit a message indicating one or more rules for the mapping between the one or more resource sets and one or more receive beams of the UE, wherein transmitting the one or more reference signals is based at least in part on the one or more rules.

5. The apparatus of claim 4, wherein the message comprises an indication of one or more resources of a first subset of the plurality of resource sets or of a second subset of the plurality of resource sets, wherein the first subset is allocated for reference signal transmission, and wherein the second subset is allocated for beam identification usage.

6. The apparatus of claim 4, wherein, to transmit the message, the processor is configured to:
transmit a medium access control control element indicating the one or more resource sets or one or more resources of the one or more resource sets, wherein the one or more messages are received based at least in part on a time delay after acknowledgement of the medium access control control element.

7. The apparatus of claim 4, wherein, to transmit the message are executable by the processor to cause the apparatus to:
transmit uplink control information indicating the one or more resource sets or one or more resources of the one or more resource sets, wherein the one or more messages are received based at least in part on a quantity of slots after transmitting the uplink control information.

8. The apparatus of claim 4, wherein the processor is further configured to:
receive the one or more messages in accordance with a plurality of pointing directions associated with the receive beam and a plurality of beamwidths associated with the receive beam; or
receive the one or more messages in accordance with a first pointing direction associated with the receive beam and a first beamwidth associated with the receive beam, the first pointing direction and the first beamwidth based at least in part on a spatial filter associated with a transmit beam of the UE used to transmit one or more reference signals.

9. The apparatus of claim 1, wherein the processor is further configured to:
receive, based at least in part on transmitting the one or more reference signals, a message indicating at least one resource of the one or more resource sets, the at least one resource for reception of the one or more messages using the receive beam, wherein the one or more messages comprise a downlink shared channel, a downlink control channel, or a combination thereof.

10. The apparatus of claim 9, wherein the message comprises one or more first identifiers associated with the at least one resource, one or more second identifiers associated with the one or more resource sets, one or more third identifiers associated with at least the receive beam, or any combination thereof.

11. The apparatus of claim 9, wherein the message comprises:
a radio resource control message indicating a transmission configuration indicator state for the UE;
a medium access control control element indicating an activation of the transmission configuration indicator state of the UE;
a downlink control information message indicating a command to switch from a first transmission indicator state of the UE to a second transmission indicator state of the UE; or
an indication of quasi co-location information for receiving the one or more messages.

12. The apparatus of claim 1, wherein the one or more reference signals are associated with an ordering that is based at least in part on one or more first identifiers associated with the one or more resource sets, one or more second identifiers associated with one or more resources of the one or more resource sets, or any combination thereof.

13. The apparatus of claim 1, wherein the processor is further configured to:
transmit a capability report indicating one or more capabilities of the UE, the one or more capabilities comprising a first quantity of resources associated with each resource set of the plurality of resource sets, a capability to support communication of the one or more reference signals via a plurality of antenna ports associated with the UE, a second quantity of antenna ports of the plurality of antenna ports associated with the first quantity of resources of each resource set of the one or more resource sets, a second quantity of resources associated with the one or more resource sets, a third quantity of active antenna ports of the plurality of antenna ports, or any combination thereof, wherein transmitting the one or more reference signals is based at least in part on transmitting the capability report.

14. The apparatus of claim 1, wherein the mapping between the one or more resource sets and the one or more receive beams of the UE is based at least in part on a frequency band associated with the one or more resource sets, a serving cell associated with the one or more resource sets, a bandwidth part associated with the one or more resource sets, or any combination thereof.

15. The apparatus of claim 1, wherein the mapping between the one or more resource sets and one or more receive beams of the UE is based at least in part on a usage mode associated with the one or more resource sets, the usage mode indicating that the plurality of resource sets correspond to the plurality of receive beams of the UE.

16. An apparatus for wireless communication at a user equipment (UE), comprising:
a memory; and
a processor coupled to the memory and configured to:
monitor a channel measurement resource for a reference signal using at least one receive beam of a plurality of receive beams of the UE;
generate at least one reference signal measurement for the reference signal based at least in part on monitoring the channel measurement resource; and
transmit a measurement report indicating the at least one reference signal measurement and indicating at least one reference signal resource that corresponds to the at least one receive beam used for monitoring the channel measurement resource, wherein the at least one reference signal resource is based at least in part on a mapping between the plurality of receive beams of the UE and a plurality of reference signal resources for the UE.

17. The apparatus of claim 16, wherein the measurement report comprises a first identifier associated with the at least one reference signal resource, a second identifier associated with a resource set for the UE comprising the at least one reference signal resource, a third identifier associated with the at least one receive beam, a spatial filter associated with a transmit beam of the UE used to transmit the measurement report, or any combination thereof.

18. The apparatus of claim 16, wherein the processor is further configured to:
transmit a capability report indicating a capability of the UE to report a quantity of receive beams associated with the at least one receive beam used to monitor the channel measurement resource, wherein the measurement report comprises an indication of the quantity of receive beams.

19. An apparatus for wireless communication at a network entity, comprising:
a memory; and
a processor coupled to the memory and configured to:
receive one or more reference signals via one or more one or more resource sets of a plurality of resource sets for a user equipment (UE), the plurality of resource sets corresponding to a plurality of receive beams of the UE, wherein the one or more resource sets indicate receive beam information of the UE based at least in part on a mapping between the one or more resource sets and one or more receive beams of the plurality of receive beams of the UE; and
transmit one or more messages to the UE, the one or more messages indicating at least one of the one or more resource sets based at least in part on the receive beam information.

20. The apparatus of claim 19, wherein the processor is further configured to:
transmit radio resource control signaling indicating one or more rules for the mapping between the one or more resource sets and one or more receive beams of the UE, wherein receiving the one or more reference signals is based at least in part on the radio resource control signaling and the one or more rules.

21. The apparatus of claim 19, wherein, to receive the one or more reference signals via the one or more resource sets, the processor is further configured to:
receive the one or more reference signals via the one or more resource sets based at least in part on a rule for the mapping between the one or more resource sets and one or more receive beams of the UE.

22. The apparatus of claim 19, wherein the processor is further configured to:
receive a message indicating one or more rules for the mapping between the one or more resource sets and one or more receive beams of the UE, wherein receiving the one or more reference signals is based at least in part on the one or more rules.

23. The apparatus of claim 22, wherein the message comprises an indication of one or more resources of a first subset of the plurality of resource sets or of a second subset of the plurality of resource sets, wherein the first subset is allocated for reference signal transmission, and wherein the second subset is allocated for beam identification usage.

24. The apparatus of claim 19, wherein the processor is further configured to:
transmit, based at least in part on receiving the one or more reference signals, a message indicating at least one resource of the one or more resource sets, the at least one resource for transmission of the one or more messages, wherein the one or more messages comprise a downlink shared channel, a downlink control channel, or a combination thereof.

25. The apparatus of claim 19, wherein the one or more reference signals are associated with an ordering that is based at least in part on one or more first identifiers associated with the one or more resource sets, one or more second indices associated with one or more resources of the one or more resource sets, or any combination thereof.

26. The apparatus of claim 19, wherein the processor is further configured to:
receive a capability report indicating one or more capabilities of the UE, the one or more capabilities comprising a first quantity of resources associated with each resource set of the plurality of resource sets, a capability to support communication of the one or more reference signals via a plurality of antenna ports associated with the UE, a second quantity of antenna ports of the plurality of antenna ports associated with the first quantity of resources of each resource set of the one or more resource sets, a second quantity of resources associated with the one or more resource sets, a third quantity of active antenna ports of the plurality of antenna ports, or any combination thereof, wherein receiving the one or more reference signals is based at least in part on transmitting the capability report.

27. The apparatus of claim 19, wherein the mapping between the one or more resource sets and the one or more receive beams of the UE is based at least in part on a frequency band associated with the one or more resource sets, a serving cell associated with the one or more resource sets, a bandwidth part associated with the one or more resource sets, or a combination thereof.

28. An apparatus for wireless communications at a network entity, comprising:
a memory; and
a processor coupled to the memory and configured to:
transmit one or more reference signals via one or more channel measurement resources; and
receive a measurement report indicating at least one reference signal measurement associated with the one or more reference signals and indicating one or more reference signal resources corresponding to one or more receive beams of a plurality of receive beams of a user equipment (UE), wherein the one or more reference signal resources are based at least in part on a mapping between the plurality of receive beams of the UE and a plurality of reference signal resources for the UE.

29. The apparatus of claim 28, wherein the measurement report comprises a first identifier associated with the at least one reference signal resource, a second identifier associated with a resource set for the UE comprising the at least one reference signal resource, a third identifier associated with the at least one receive beam, a spatial filter associated with a transmit beam of the UE used to transmit the measurement report, or any combination thereof.

30. The apparatus of claim 28, wherein the processor is further configured to:
receive a capability report indicating a capability of the UE to report a quantity of receive beams associated with the at least one receive beam used to monitor the channel measurement resource, wherein the measurement report comprises an indication of the quantity of receive beams.
